(19) United States
(12) Patent Application Publication
(10) Pub. No.: US 2025/0145457 A1
(43) Pub. Date: May 8, 2025

(54) METHOD FOR AMMONIA DECOMPOSITION TO HYDROGEN AND NITROGEN

(71) Applicant: KING FAHD UNIVERSITY OF PETROLEUM AND MINERALS, Dhahran (SA)

(72) Inventors: Mohammad Mozahar HOSSAIN, Dhahran (SA); Omar Mohammad O. ALAMOUDI, Dhahran (SA); Wasim Ullah KHAN, Dhahran (SA); Syed Ahmed ALI, Dhahran (SA); Dwi HANTOKO, Dhahran (SA)

(73) Assignee: KING FAHD UNIVERSITY OF PETROLEUM AND MINERALS, Dhahran (SA)

(21) Appl. No.: 18/504,647

(22) Filed: Nov. 8, 2023

(51) Int. Cl. C01B 3/04; B01J 8/02; B01J 23/755; B01J 23/78; B01J 35/10; B01J 37/03; B01J 37/04; B01J 37/06; B01J 37/08; B01J 37/18; B01J 37/34

(52) U.S. Cl. CPC C01B 3/047; B01J 8/025; B01J 8/0278; B01J 23/755; B01J 23/78; B01J 35/613; B01J 35/633; B01J 37/035; B01J 37/04; B01J 37/06; B01J 37/08; B01J 37/18; B01J 37/343; B01J 2208/00876

(57) ABSTRACT

A method for ammonia (NH₃) decomposition to hydrogen (H₂) and nitrogen (N₂) includes introducing and passing a H₂-containing feed gas stream into a reactor containing an industrial waste-based nickel (Ni-SMR) catalyst at a temperature of 500 to 900° C. to form a reduced Ni-SMR catalyst; introducing and passing an NH₃-containing feed gas stream through the reactor in contact with the reduced Ni-SMR catalyst at a temperature of 100 to 1000° C. thereby converting at least a portion of the NH₃ to H₂ and regenerating the Ni-SMR catalyst particles to form a regenerated Ni-SMR catalyst, and producing a residue gas stream leaving the reactor; and separating the H₂ from the residue gas stream to generate a H₂-containing product gas stream.

### STATEMENT OF ACKNOWLEDGEMENT

This research was supported by the Interdisciplinary Research Center for Refining and Advanced Chemicals at King Fahd University of Petroleum and Minerals (KFUPM), Dhahran, Saudi Arabia, under the Project INRC2113.

### BACKGROUND

### Technical Field

The present disclosure is directed to hydrogen production, and particularly to a method for ammonia (NH₃) decomposition to hydrogen (H₂) and nitrogen (N₂) using an industrial waste-based nickel (Ni-SMR) catalyst.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Fossil fuels are traditionally used as energy sources across multiple sectors, such as transportation, manufacturing, and everyday activities. Unfortunately, this heavy reliance on fossil fuels leads to significant CO₂ emissions, contributing to the global warming crisis. To address this issue, substantial efforts have been undertaken to reduce dependence on fossil fuels, with hydrogen emerging as a promising clean energy alternative. However, the storage of hydrogen presents challenges due to its inherently low energy density. It is typically stored either as a highly compressed gas or a cryogenic liquid. Furthermore, hydrogen diffusion through storage materials poses risks and hampers its widespread practical use as a fuel. Production of hydrogen is achieved through various hydrogen carrier conversion methods, such as hydrocarbon reforming, conventional and hybrid water electrolysis, and ammonia decomposition (See: I. Lucentini, X Garcia, X Vendrell, J. Llorca, Review of the Decomposition of Ammonia to Generate Hydrogen, Ind Eng Chem Res. 60 (2021) 18560-18611). Ammonia stands out among the various hydrogen carriers due to its potential advantages. These includes high energy density and hydrogen storage capacity, surpassing other materials. The conversion of ammonia into H₂ does not result in any COₓ emissions, and ammonia is easily liquefiable and transportable. Furthermore, ammonia exhibits high selectivity in decomposition, producing only hydrogen and stoichiometric amount of nitrogen.

Waste materials derived from diverse industries often possess significant concentrations of metals and metal oxides, rendering them promising candidates for cost-effective catalyst utilization. One such waste byproduct is derived from the alkaline treatment of bauxite ores in alumina manufacturing, commonly referred to as industrial solid waste material (SMR) or bauxite residue. For every ton of alumina produced, approximately one to two tons (dry weight) of bauxite leftovers are generated. This industrial solid waste material is a by-product generated during the extraction of alumina from bauxite using caustic soda in the Bayer process, and it typically constitutes around 35-40% of bauxite ore, which is disposed of as an alkaline RM slurry (See: J. Yang, B. Xiao, Development of unsintered construction materials from red mud wastes produced in the sintering alumina process, Constr Build Mater. 22 (2008) 2299-2307). SMR can also potentially affect the environment, groundwater, and marine life. The disposal of red mud requires substantial land area, which can encroach upon available agricultural land.

Currently, SMR produced by alumina plants is primarily disposed of in landfills or deposited in the ocean, with its usage largely limited to road construction, land reclamation, and cement production. However, significant efforts are underway to explore new avenues for SMR, including metal recovery of iron, aluminum, titanium, and other trace metals. SMR demonstrates its environmental-friendliness and cost-effectiveness as an adsorbent in wastewater treatment and waste gas cleaning. Its ability to remove contaminants without leaching or secondary contamination is of great value. Additionally, SMR finds applications in the development of building materials, soil amendments, and other bulk applications, offering economic benefits and zero waste disposal. Moreover, the catalytic properties of SMR make it suitable for industrial processes, further enhancing its versatility and potential as a valuable resource in multiple industries. The composition of the mud reveals the presence of significant metal oxides, including Fe₂O₃, SiO₂, Al₂O₃, and TiO₂. On the other hand, the presence of sodium and calcium oxides in SMR poses a challenge when attempting to employ it as a catalyst through high-temperature sintering. A chemical analysis shows that SMR contains silica, aluminum, iron, calcium, titanium, and a variety of other minor components, including Na, K, Cr, V, Ni, Ba, Cu, Mn, Pb, and Zn [See: S. Wang, H. M. Ang, M. O. Tadé, Novel applications of red mud as coagulant, adsorbent and catalyst for environmentally benign processes, Chemosphere. 72 (2008) 1621-1635].

The catalytic activity of transition metals in ammonia (NH₃) synthesis relies on the chemisorption energy of nitrogen (N), as evidenced by the established linear correlation between the dissociation energy of N₂ and the adsorption energy of nitrogen (See: J. W. Makepeace, T. He, C. Weidenthaler, T. R. Jensen, F. Chang, T. Vegge, P. Ngene, Y. Kojima, P. E. de Jongh, P. Chen, W. I. F. David, Reversible ammonia-based and liquid organic hydrogen carriers for high-density hydrogen storage: Recent progress, Int J Hydrogen Energy. 44 (2019) 7746-7767). The thermal decomposition of ammonia, which is the reverse reaction of the Haber-Bosch process for ammonia synthesis, focused on employing the same catalysts (Ru and Fe). This was based on the principle of microreversibility in heterogeneous catalysis and their moderate adsorption energy for N₂. Subsequently, Cu-based catalysts were investigated, along with various other metals such as Ni, Ir, Mo, Co, Pt, Pd, and Rh, as well as different combinations of metals including Co—Mo, Ni—Mo, Fe—Mo, Ni—Co, Co—Mo—Fe—Ni—Cu, Mg—Fe, Fe—Co, Ni—Fe, Mg—Co—Fe, Ni—Pt, Ni—Pd, Ir—Ni, Cu—Zn, and bimetallic compositions containing Ru. The substantial iron content in SMR serve as a catalyst for oxidizing volatile organic compounds (VOCs). Ru and Fe-based catalysts have been considered as alternatives for decomposing ammonia into hydrogen and nitrogen. Although Ru-based catalysts are recognized for their high activity, their limited availability and high-cost present challenges. Ni- and Fe-based catalysts offer promising alternatives as they exhibit relatively high hydrogen production rates. However, these non-noble metal catalysts require elevated temperatures to achieve optimal hydrogen production, which can lead to sintering and deactivation issues.

Nickel on alumina is a catalyst that has been used on a large scale for the breakdown of ammonia. Nickel on alumina catalysts often have high mechanical strength and heat resistance (See: A. Klerke, C. H. Christensen, J. K. Norskov, T. Vegge, Ammonia for hydrogen storage: Challenges and opportunities, J Mater Chem. 18 (2008) 2304-2310). Among the various catalysts, ruthenium supported on different oxides or carbon structures has shown the highest catalytic activity for ammonia decomposition. However, ruthenium is a rare and expensive noble metal, leading to the search for low-cost alternatives with comparable activity. Nickel supported on alumina is commonly used in industrial ammonia crackers. Doping alumina with lanthanum or rare earth oxides as promoters has enhanced the catalytic activity of nickel-based catalysts. Silica in various forms, such as SiO₂, mesoporous structures, or natural minerals, may be used as a support for nickel catalysts. Zirconium-based supports and carbon-based materials like carbon nanotubes and graphene have been investigated. Additionally, SMR holds promise as a cost-effective support for nickel catalysts. Therefore, there is a need for a cost-effective catalyst that demonstrates both high and stable performance for ammonia decomposition.

In view of the foregoing, one object of the present disclosure is to provide a method for ammonia (NH₃) decomposition to hydrogen (H₂) and nitrogen (N₂). This catalytic ammonia decomposition process employs SMR as a supporting material for Ni catalysts. A second object of the present disclosure is to provide a method of making the industrial waste based nickel (Ni-SMR) catalyst.

### SUMMARY

In an exemplary embodiment, a method for ammonia (NH₃) decomposition to hydrogen (H₂) and nitrogen (N₂) is described. The method includes introducing a H₂-containing feed gas stream into a reactor containing an industrial waste-based nickel (Ni-SMR) catalyst comprising Ni-SMR catalyst particles. In some embodiments, Nickel (Ni) is present in the Ni-SMR catalyst at a concentration of 5 to 30 wt. % based on a total weight of the Ni-SMR catalyst. The method further includes passing the H₂-containing feed gas stream through the reactor to contact the H₂-containing feed gas stream with the Ni-SMR catalyst particles at a temperature of 500 to 900° C. to form a reduced Ni-SMR catalyst. The method further includes terminating introduction of the H₂-containing feed gas stream and introducing and passing an NH₃-containing feed gas stream through the reactor to contact the NH₃-containing feed gas stream with the reduced Ni-SMR catalyst at a temperature of 100 to 1000° C., thereby converting at least a portion of the NH₃ to H₂ and regenerating the Ni-SMR catalyst particles to form a regenerated Ni-SMR catalyst and producing a residue gas stream leaving the reactor. The method further includes separating the H₂ from the residue gas stream to generate a H₂-containing product gas stream.

In some embodiments, the Ni-SMR catalyst has a temperature-programmed reduction (H₂-TPR) of 2.5 to 3.5 millimoles (mmol) of H₂ per gram of the Ni-SMR catalyst.

In some embodiments, the Ni-SMR catalyst has an activation energy of 80 to 90 kilojoules per mole (kJ/mol).

In some embodiments, the H₂ is present in the H₂-containing feed gas stream at a concentration of 90 to 99.99 vol. % based on a total volume of the H₂-containing feed gas stream.

In some embodiments, the NH₃ is present in the NH₃-containing feed gas stream at a concentration of 5 to 20 vol. % based on a total volume of the NH₃-containing feed gas stream.

In some embodiments, the NH₃-containing feed gas stream further includes an inert gas selected from the group consisting of nitrogen, argon, and helium. In some embodiments, a volume ratio of the NH₃ to the inert gas present in the NH₃-containing feed gas stream is in a range of 1:4 to 1:20.

In some embodiments, the NH₃-containing feed gas stream further includes helium, and the residue gas stream leaving the reactor includes ammonia, nitrogen, helium, and hydrogen.

In some embodiments, the reactor is at least one selected from the group consisting of a fixed-bed reactor, a trickle-bed reactor, a moving bed reactor, a rotating bed reactor, a fluidized bed reactor, and a slurry reactor.

In some embodiments, the reactor is a fixed-bed reactor in the form of a cylindrical reactor. In some embodiments, the cylindrical reactor includes a top portion, a cylindrical body portion, a bottom portion, and a housing having an open top and open bottom supportably maintained with the cylindrical body portion. In some embodiments, the Ni-SMR catalyst is supportably retained within the housing, permitting fluid flow therethrough. In some embodiments, the reactor further includes at least one propeller agitator disposed in the bottom portion of the reactor. In some embodiments, the bottom portion is cone-shaped or pyramidal. In some embodiments, a plurality of recirculation tubes fluidly connects the bottom portion of the cylindrical reactor with the cylindrical body portion of the cylindrical reactor.

In some embodiments, the reactor has an aspect ratio of length (L) to inner diameter (ID) of 10:1 to 50:1.

In some embodiments, the passing the H₂-containing feed gas stream through the reactor is carried out at a weight hourly space velocity of about 9000 mL/g_{cat}/hr at a temperature of about 700° C.

In some embodiments, the passing the NH₃-containing feed gas stream through the reactor is carried out at a weight hourly space velocity of 4500 to 8100 mL/g_{cat}/hr at a temperature of about 500 to 600° C.

In some embodiments, the method has an ammonia conversion of 60 to 99% based on an initial concentration of the NH₃ in the feed gas stream.

In some embodiments, the method includes preparing the Ni-SMR catalyst by calcining an industrial waste material at a temperature of about 800° C. to form a treated material, and dispersing the treated material in water and sonicating to form a dispersion. The method further includes mixing the dispersion, a Ni salt, and an alkaline solution to form a slurry and heating the slurry to form a crude product suspended in the slurry. The method further includes removing the crude product from the slurry, washing, and calcining at a temperature of about 550° C. to form the Ni-SMR catalyst. In some embodiments, the Ni-SMR catalyst has a Ni content of about 10 to 20 wt. % based on the total weight of the Ni-SMR catalyst.

In some embodiments, the industrial waste material includes about 40 to 60 wt. % Fe₂O₃, about 10 to 30 wt. % Al₂O₃, about 10 to 30 wt. % SiO₂, less than 10 wt. % CaO, and less than 10 wt. % Na₂O, each wt. % based on a total weight of the industrial waste material.

In some embodiments, the industrial waste material includes about 50 wt. % Fe₂O₃, about 20 wt. % Al₂O₃, about 20 wt. % SiO₂, less than 10 wt. % CaO, and less than 10 wt. % Na₂O, each wt. % based on the total weight of the industrial waste material.

In some embodiments, the treated material has a specific surface area in a range of 15 to 25 square meter per gram (m²/g).

In some embodiments, the treated material has a cumulative pore volume in a range of 0.05 to 0.06 cubic centimeter per gram (cm³/g).

In some embodiments, the Ni salt includes nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate.

In some embodiments, the alkali solution includes at least one alkali salt selected from the group consisting of potassium hydroxide (KOH), sodium hydroxide (NaOH), calcium hydroxide (Ca(OH)₂), potassium carbonate (K₂CO₃), sodium carbonate (Na₂CO₃), and calcium carbonate (Ca₂CO₃).

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow diagram of a method for ammonia (NH₃) decomposition to hydrogen (H₂) and nitrogen (N₂), according to certain embodiments;

FIG. 1B is a schematic flow diagram of a method for preparing the industrial waste-based nickel (Ni-SMR) catalyst, according to certain embodiments;

FIG. 2 is a schematic diagram of a fixed bed reactor used for NH₃ decomposition in the presence of the Ni-SMR catalyst, according to certain embodiments;

FIG. 3 shows X-ray diffraction (XRD) profiles of various Ni-SMR catalysts, according to certain embodiments;

FIG. 4 shows temperature-programmed reduction (TPR) profiles of various Ni-SMR catalysts, according to certain embodiments;

FIG. 5A shows a total area of peak of the TPR profile of the SMR catalyst, according to certain embodiments;

FIG. 5B shows a total area of peak of the TPR profile of 10Ni-SMR catalyst, according to certain embodiments;

FIG. 5C shows a total area of peaks of the TPR profile of 15Ni-SMR catalyst, according to certain embodiments;

FIG. 5D shows a total area of peak of the TPR profile of 20Ni-SMR catalyst, according to certain embodiments;

FIG. 6A shows experimental vs. model predicted non-isothermal reduction [α(t)] of SMR catalysts sample, according to certain embodiments;

FIG. 6B shows experimental vs. model predicted non-isothermal reduction [α(t)] of the 10Ni-SMR catalysts sample, according to certain embodiments;

FIG. 6C shows experimental vs. model predicted non-isothermal reduction [α(t)] of the 15Ni-SMR catalysts sample, according to certain embodiments;

FIG. 6D shows experimental vs. model predicted non-isothermal reduction [α(t)] of the 20Ni-SMR catalysts sample, according to certain embodiments;

FIG. 7 shows activities of the Ni-SMR catalysts with different Ni loading (0, 10, 15, 20, 15 wt. %), equilibrium conversion (using Aspen plus to minimize Gibbs energy with Ping Robinson equation of state) and thermal (refers to reactor without catalyst loading), according to certain embodiments;

FIG. 8 shows a time dependence of the catalytic activity of the 15Ni-SMR catalyst, according to certain embodiments;

FIG. 9A shows a variation of the ammonia conversion with temperature for the 15Ni-SMR catalyst, according to certain embodiments;

FIG. 9B shows feed flow rate effect on conversion for the 15Ni-SMR catalyst, according to certain embodiments;

FIG. 10 shows XRD profiles of fresh and spent 15Ni-SMR catalyst, according to certain embodiments;

FIG. 11A shows a comparison of the 10Ni-SMR catalyst with different nickel-based catalysts, according to certain embodiments; and

FIG. 11B shows a comparison of 15Ni-SMR catalyst with different nickel-based catalysts, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, the term “porosity” refers to a measure of the void or vacant spaces within a material.

As used herein, the terms “particle size” and “pore size” may be thought of as the lengths or longest dimensions of a particle and of a pore opening, respectively.

As used herein, the term “sonication” refers to the process in which sound waves are used to agitate particles in a solution.

As used herein the term “deionized water” refers to the water that has (most of) the ions removed.

As used herein, the term “calcination” refers to heating a compound to a high temperature, under a restricted supply of ambient oxygen, causing the compound to undergo chemical and physical transformations. This is also performed to remove impurities or volatile substances and to incur thermal decomposition.

As used herein, the term “thermal decomposition (or thermolysis)” refers to a chemical decomposition initiated by heat. The decomposition temperature is the temperature at which a substance undergoes chemical decomposition.

As used herein, the term “temperature-programmed reduction (TPR)” refers to a technique for characterizing solid materials. It is often used in the domain of heterogeneous catalysis to find the optimal reduction conditions; an oxidized catalyst precursor is submitted to a programmed temperature rise whereas a reducing gas mixture is flowed over it.

As used herein, the term “aspect ratio” refers to the ratio of length to width of cylinder.

As used herein, the term “weight hourly space velocity (WHSV)” refers to the weight of feed flowing per unit weight of the catalyst per hour.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all hydration states of a given compound or formula, unless otherwise noted or when heating a material. The present disclosure is intended to include all isotopes of a given compound or formula, unless otherwise noted.

Aspects of the present disclosure are directed towards an industrial solid waste material (SMR) with/without additional nickel loading as an active catalyst for low-temperature ammonia decomposition to produce high-purity hydrogen.

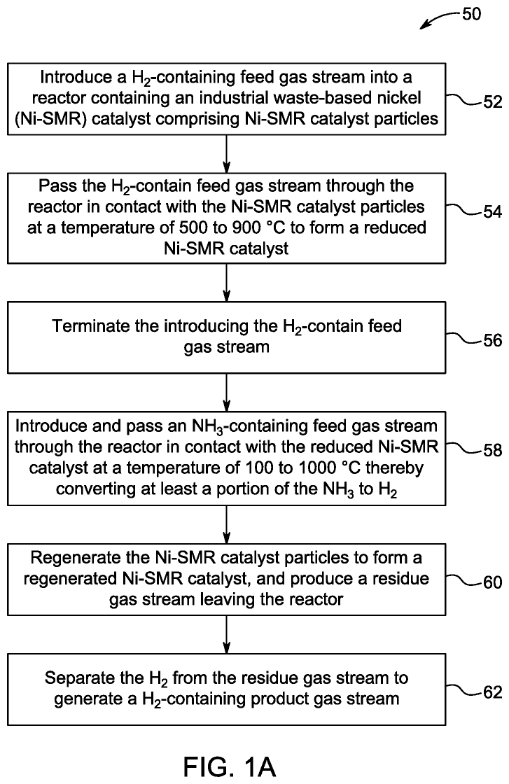

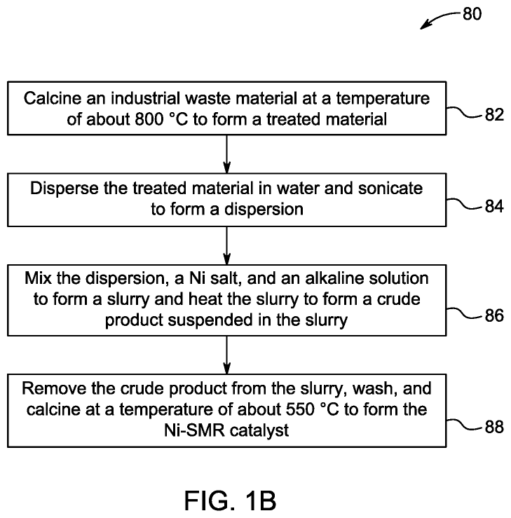

FIG. 1A illustrates a flow chart of a method 50 for ammonia (NH₃) decomposition to hydrogen (H₂) and nitrogen (N₂). The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes introducing a H₂-containing feed gas stream into a reactor containing an industrial waste-based nickel (Ni-SMR) catalyst comprising Ni-SMR catalyst particles. In some embodiments, the H₂ is present in the H₂-containing feed gas stream at a concentration of 90-99.99 vol. %, preferably 90.5-99.5 vol. %, preferably 91-99 vol. %, preferably 91.5-98.5 vol. %, preferably 92-98 vol. %, preferably 92.5-97.5 vol. %, preferably 93-97 vol. %, preferably 93.5-96.5 vol. %, preferably 94-96 vol. %, preferably 94.5-95.5 vol. %, based on a total volume of the H₂-containing feed gas stream. Other ranges are also possible.

In some embodiments, Ni is present in the Ni-SMR catalyst at a concentration of 5-30 wt. %, preferably 6-29 wt. %, preferably 7-28 wt. %, preferably 8-27 wt. %, preferably 9-26 wt. %, preferably 10-25 wt. %, preferably 11-24 wt. %, preferably 12-23 wt. %, preferably 13-22 wt. %, preferably 14-21 wt. %, preferably 15-20 wt. %, preferably 16-19 wt. %, and preferably 17-18 wt. %, based on a total weight of the Ni-SMR catalyst. In one embodiment, Ni is present in the Ni-SMR catalyst at a concentration of 10 wt. %. In another embodiment, Ni is present in the Ni-SMR catalyst at a concentration of 15 wt. %. In yet another embodiment, Ni is present in the Ni-SMR catalyst at a concentration of 20 wt. %. Other ranges are also possible. In some embodiments, the Ni is homogenously distributed throughout the Ni-SMR catalyst. In yet further embodiments, the Ni is disposed on surfaces of particles of the Ni-SMR catalyst.

As used herein, the term “temperature program reduction using H₂,” or “H₂-TPR”, generally refers to a technique used to study the reducibility of a solid material, such as an Ni-SMR catalyst, by measuring the consumption of a reducing gas, such as hydrogen, as a function of temperature. In some embodiments, the Ni-SMR catalyst is first heated in an oxidizing gas, such as air or oxygen, to remove any adsorbed species and to convert the active catalyst composition to an oxide. In some further embodiments, the alumina-supported Ga₂O₃/La₂O₃ catalyst is then cooled down and exposed to a stream of hydrogen gas, while the temperature is gradually increased. As the temperature increases, the hydrogen reacts with the oxidized active catalyst composition, causing a reduction of the material. In some preferred embodiments, this reduction reaction may be exothermic, and the heat generated by the reaction is monitored as a function of temperature.

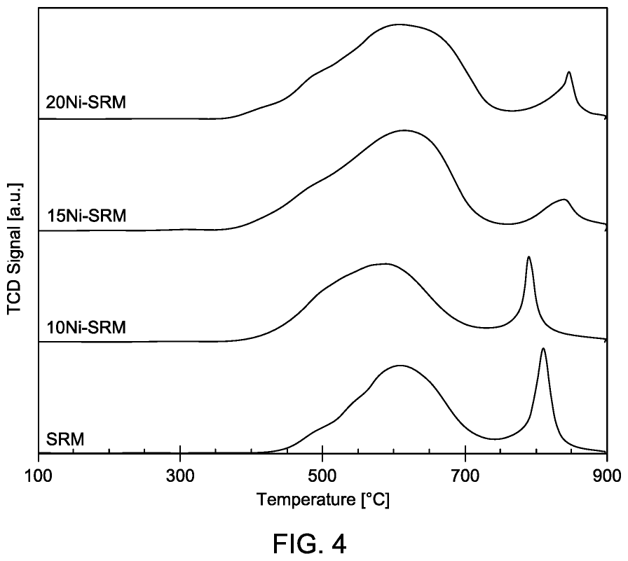

Referring to FIG. 4, hydrogen-temperature programmed reduction (H₂-TPR) profiles of various Ni-SMR catalysts. In some embodiments, the H₂-TPR was conducted on a Micromeritics AutoChem-II 2920 unit equipped with a TCD detector. The Ni-SMR catalyst was placed in a quartz calcined at a temperature of 50 to 400° C., preferably 75 to 350° C., preferably 100 to 300° C., preferably 125 to 250° C., or even more preferably about 150° C. under an argon flow for at least 60 minutes, at least 120 minutes, at least 180 minutes. In some further embodiments, the Ni-SMR catalyst was cooled to a temperature of no more than 70° C., preferably no more than 60° C., or even more preferably no more than 50° C. In some preferred embodiments, a gas flow contains hydrogen (H₂) and argon (Ar) in a volumetric ratio of H₂ to Ar ranging from 1:20 to 1:1, preferably 1:15 to 1:5, or even more preferably about 1:10 was introduced to flow over the active catalyst composition at a flow rate of 10 to 100 cubic centimeters per minutes (cm³/min), preferably 30 to 70 cm³/min, or even more preferably about 50 cm³/min. In some preferred embodiments, the temperature of the analyzer containing the active catalyst was increased at ramping rate of 5 to 20° C. per minute until the temperature reaches about 900° C. Other ranges are also possible.

In some embodiments, the Ni-SMR catalyst has a temperature-programmed reduction (H₂-TPR) of 1 to 5 millimoles of H₂ per gram of the Ni-SMR catalyst (mmol/g), preferably 2.5-3.5, preferably 2.6-3.4, preferably 2.7-3.3, preferably 2.8-3.2, and preferably 2.9-3.1 mmol/g. In a specific embodiment, the Ni-SMR catalyst has a H₂-TPR of 2.77 mmol/g. In some embodiments, the Ni-SMR catalyst has an activation energy of 80-90 kilojoules per mole (kJ/mol), preferably 81-89 kJ/mol, preferably 82-88 kJ/mol, preferably 83-87 kJ/mol, and preferably 84-86 kJ/mol, as determined by the Arrhenius equation. In an embodiment, the Ni-SMR catalyst has an activation energy of 86.6 kJ/mol. In another embodiment, the Ni-SMR catalyst has an activation energy of 84.2 kJ/mol. In yet another embodiment, the Ni-SMR catalyst has an activation energy of 83.4 kJ/mol. In a preferred embodiment, the Ni-SMR catalyst has an activation energy of 86.6 kJ/mol. Other ranges are also possible.

At step 54, the method 50 includes passing the H₂-containing feed gas stream through the reactor to contact the H₂-containing feed gas stream with the Ni-SMR catalyst particles at a temperature of 500-900° C., preferably 510-890° C., preferably 520-880° C., preferably 530-870° C., preferably 540-860° C., preferably 550-850° C., preferably 560-840° C., preferably 570-830° C., preferably 580-820° C., preferably 590-810° C., preferably 600-800° C., preferably 610-790° C., preferably 620-780° C., preferably 630-770° C., preferably 640-760° C., preferably 650-750° C., preferably 660-740° C., preferably 670-730° C., preferably 680-720° C., preferably 690-710° C., to form a reduced Ni-SMR catalyst. In a specific embodiment, the H₂-containing feed gas stream is passed through the reactor in contact with the Ni-SMR catalyst particles at a temperature of 700° C. Other ranges are also possible.

In some embodiments, the passing of the H₂-containing feed gas stream through the reactor is carried out at a WHSV (WHSV) of about 4000-11000 mL/g_{cat}/hr, preferably 4500-10500, preferably 5000-10000, preferably 5500-9500, preferably 6000-9000, preferably 6500-8500, and preferably 7000-8000 mL/g_{cat}/hr at a temperature of about 500-900° C., preferably 510-890° C., preferably 520-880° C., preferably 530-870° C., preferably 540-860° C., preferably 550-850° C., preferably 560-840° C., preferably 570-830° C., preferably 580-820° C., preferably 590-810° C., preferably 600-800° C., preferably 610-790° C., preferably 620-780° C., preferably 630-770° C., preferably 640-760° C., preferably 650-750° C., preferably 660-740° C., preferably 670-730° C., preferably 680-720° C., preferably 690-710° C. In a specific embodiment, the passing of the H₂-containing feed gas stream through the reactor is carried out at a WHSV of about 9000 mL/g_{cat}/hr at a temperature of about 700° C. Other ranges are also possible.

At step 56, the method 50 includes terminating the introducing the H₂-containing feed gas stream. The reactor temperature is subsequently set to the targeted study condition under a continuous flow of an inert gas, preferably nitrogen, preferably argon, and more preferably helium. In a specific embodiment, the reactor temperature is subsequently set to the targeted study condition under a continuous flow of helium.

At step 58, the method 50 includes introducing and passing an NH₃-containing feed gas stream through the reactor to contact the NH₃-containing feed gas stream with the reduced Ni-SMR catalyst at a temperature of 100-1000° C., preferably 125-975° C., preferably 150-950° C., preferably 175-925° C., preferably 200-900° C., preferably 225-875° C., preferably 250-850° C., preferably 275-825° C., preferably 300-800° C., preferably 325-775° C., preferably 350-750° C., preferably 375-725° C., preferably 400-700° C., preferably 425-675° C., preferably 450-650° C., preferably 475-625° C., preferably 500-600° C., and preferably 525-575° C., thereby converting at least a portion of the NH₃ to H₂. In a specific embodiment, the NH₃-containing feed gas stream is introduced and passed through the reactor in contact with the reduced Ni-SMR catalyst at a temperature of 900° C. Other ranges are also possible.

In some embodiments, the NH₃-containing feed gas stream further includes an inert gas selected from the group consisting of nitrogen, argon, and helium. In a specific embodiment, the inert gas is helium. The volume ratio of the NH₃ to the inert gas present in the NH₃-containing feed gas stream is in the range of 1:4-1:20, preferably 1:5-1:19, preferably 1:6-1:18, preferably 1:7-1:17, preferably 1:8-1:16, preferably 1:9-1:15, preferably 1:10-1:14, and preferably 1:11-1:13. Other ranges are also possible.

In some embodiments, the passing the NH₃-containing feed gas stream through the reactor is carried out at a WHSV of 4500-8100 mL/g_{cat}/hr, preferably 4600-8000, preferably 4700-7900, preferably 4800-7800, preferably 4900-7700, preferably 5000-7600, preferably 5100-7500, preferably 5200-7400, preferably 5300-7300, preferably 5400-7200, preferably 5500-7100, preferably 5600-7000, preferably 5700-6900, preferably 5800-6800, preferably 5900-6700, preferably 6000-6600, preferably 6100-6500, and preferably 6200-6400 mL/g_{cat}/hr at a temperature of about 500-600° C., preferably 510-590° C., preferably 520-580° C., preferably 530-570° C., and preferably 540-560° C. In a specific embodiment, the passing the NH₃-containing feed gas stream through the reactor is carried out at a WHSV of 6000 mL/g_{cat}/hr at a temperature of about 550° C. Other ranges are also possible.

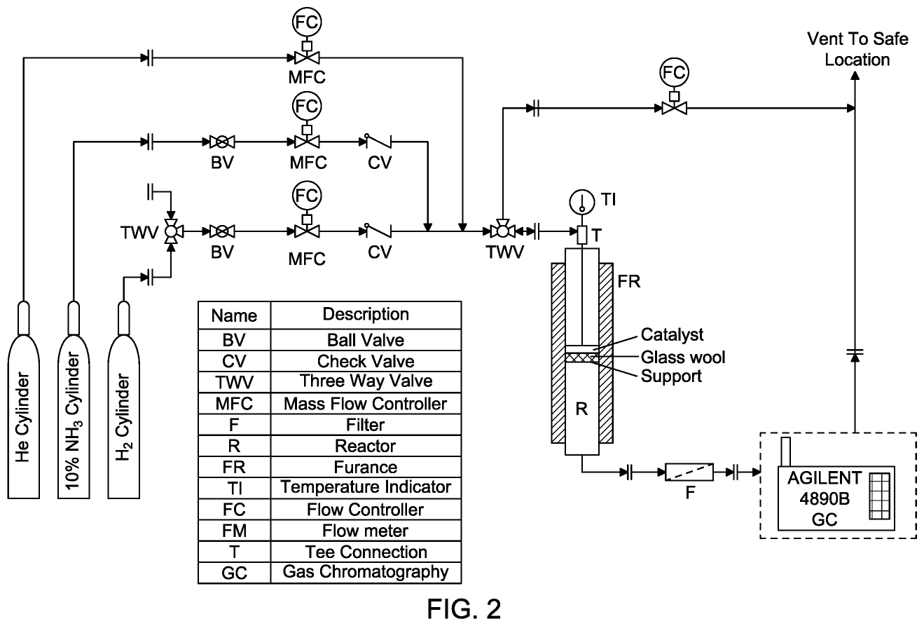

In some embodiments, the reactor is at least one selected from the group consisting of a fixed-bed reactor, a trickle-bed reactor, a moving bed reactor, a rotating bed reactor, a fluidized bed reactor, and a slurry reactor. In a specific embodiment, the reactor is a fixed-bed bed stainless steel tubular reactor, as depicted in FIG. 2. In an embodiment, the reactor is the fixed-bed reactor in the form of a cylindrical reactor including a top portion, a cylindrical body portion, a bottom portion, and a housing having an open top and open bottom supportably maintained with the cylindrical body portion. In some embodiments, the Ni-SMR catalyst is supportably retained within the housing permitting fluid flow therethrough. The housing may further includes a glass wool support that retains the particles of the Ni-SMR catalyst. In some embodiments, the bottom portion is cone-shaped or pyramidal. In some embodiments, at least one propeller agitator is disposed in the bottom portion of the reactor. In some embodiments, a plurality of recirculation tubes fluidly connects the bottom portion of the cylindrical reactor with the cylindrical body portion of the cylindrical reactor. In some embodiments, the reactor has an aspect ratio of length (L) to the inner diameter (ID) of 10:1-50:1, preferably 15:1-45:1, preferably 20:1-40:1, and preferably 25:1-35:1. In a specific embodiment, the reactor has an aspect ratio of 22:1. Other ranges are also possible.

In some embodiments, the NH₃ is present in the NH₃-containing feed gas stream at a concentration of 5-20 vol. %, preferably 6-19 vol. %, preferably 7-18 vol. %, preferably 8-17 vol. %, preferably 9-16 vol. %, preferably 10-15 vol. %, preferably 11-14 vol. %, and preferably 12-13 vol. %, based on a total volume of the NH₃-containing feed gas stream. In a specific embodiment, the NH₃ is present in the NH₃-containing feed gas stream at a concentration of 10 vol. %. Other ranges are also possible. Other components of the NH₃-containing feed gas stream are preferably inert gases such as N₂, CO₂, etc.

At step 60, the method 50 includes regenerating the Ni-SMR catalyst particles to form a regenerated Ni-SMR catalyst, and producing a residue gas stream leaving the reactor. In some embodiments, the residue gas stream leaving the reactor includes ammonia, nitrogen, helium, and hydrogen. Hydrogen is released as a result of the reduction of ammonia to hydrogen by Ni-SMR catalysts. In some embodiments, NH₃ conversion of 60-99%, preferably 61-98%, preferably 62-97%, preferably 63-96%, preferably 64-95%, preferably 65-94%, preferably 66-93%, preferably 67-92%, preferably 68-91%, preferably 69-90%, preferably 70-89%, preferably 71-88%, preferably 72-87%, preferably 73-86%, preferably 74-85%, preferably 75-84%, and preferably 76-83% occurs based on an initial concentration of the NH₃ in the feed gas stream. In a preferred embodiment, the NH₃ conversion of 87% occurs based on an initial concentration of the NH₃ in the feed gas stream. Other ranges are also possible.

At step 62, the method 50 includes separating the H₂ from the residue gas stream to generate a H₂-containing product gas stream. In some embodiments, the separating the H₂ is performed by techniques such as pressure swing adsorption (PSA), membrane separation, cryogenic distillation, chemical reactions, water-gas shift reaction, and/or other techniques that are known to those skilled in the art.

In some embodiments, the separating is performed by introducing the residue gas stream into a hydrogen purification device including one or more hydrogen-selective membranes. Hydrogen purification device is configured to separate hydrogen from the residue gas stream and purifying the same. In an example, the hydrogen purification device may be a palladium membrane hydrogen purifier. The palladium membrane may include metallic tubes of palladium and silver alloy for allowing only monatomic hydrogen to pass through its crystal lattice when it is heated above 300° C. The hydrogen-selective membranes are permeable to hydrogen gas but are at least substantially impermeable to other components in the residue gas stream. In some embodiments, the plurality of hydrogen-selective membranes in the hydrogen purification device is arranged in parallel, and each membrane of the plurality of hydrogen-selective membranes is placed in a plane perpendicular to a direction of the gas mixture flow in the hydrogen purification device. The method 50 may further include passing the residue gas stream through the plurality of hydrogen-selective membranes in the hydrogen purification device thereby allowing hydrogen gas to pass through the hydrogen-selective membrane and rejecting other components in the residue gas stream to form a residue composition. The method 50 may further include collecting the hydrogen gas after passing and recycling the residue composition.

FIG. 1B illustrates a flow chart of a method 80 for preparing the Ni-SMR catalyst. The order in which the method 80 is described is not intended to be construed as a limitation, and any number of the described method steps can be combined in any order to implement the method 80. Additionally, individual steps may be removed or skipped from the method 80 without departing from the spirit and scope of the present disclosure.

At step 82, the method 80 includes calcining an industrial waste material at a temperature of about 800° C. to form a treated material. In some embodiments, the industrial waste material includes about 40-60 wt. % Fe₂O₃, preferably 41-59 wt. %, preferably 42-58 wt. %, preferably 43-57 wt. %, preferably 44-56 wt. %, preferably 45-55 wt. %, preferably 46-54 wt. %, preferably 47-53 wt. %, preferably 48-52 wt. %, or even more preferably 49-51 wt. % Fe₂O₃; about 10-30 wt. % Al₂O₃, preferably 11-29 wt. %, preferably 12-28 wt. %, preferably 13-27 wt. %, preferably 14-26 wt. %, preferably 15-25 wt. %, preferably 16-24 wt. %, preferably 17-23 wt. %, preferably 18-22 wt. %, or even more preferably 19-21 wt. % Al₂O₃; about 10 to 30 wt. % SiO₂, preferably 11-29 wt. %, preferably 12-28 wt. %, preferably 13-27 wt. %, preferably 14-26 wt. %, preferably 15-25 wt. %, preferably 16-24 wt. %, preferably 17-23 wt. %, preferably 18-22 wt. %, or even more preferably 19-21 wt. % SiO₂; less than 10 wt. % CaO, preferably 9 wt. %, preferably 8 wt. %, preferably 7 wt. %, preferably 6 wt. %, preferably 5 wt. %, preferably 4 wt. %, preferably 3 wt. %, preferably 2 wt. %, or even more preferably 1 wt. % CaO; and less than 10 wt. % Na₂O, preferably 9 wt. %, preferably 8 wt. %, preferably 7 wt. %, preferably 6 wt. %, preferably 5 wt. %, preferably 4 wt. %, preferably 3 wt. %, preferably 2 wt. %, or even more preferably 1 wt. % Na₂O, each wt. % based on the total weight of the industrial waste material. In a preferred embodiment, the industrial waste material includes about 50 wt. % Fe₂O₃, about 20 wt. % Al₂O₃, about 20 wt. % SiO₂, less than 10 wt. % CaO, and less than 10 wt. % Na₂O, each wt. % based on the total weight of the industrial waste material. Other ranges are also possible.

In some embodiments, the treated material has a specific surface area in a range of 15-25 square meters per gram (m²/g), preferably 16-24 m²/g, preferably 17-23 m²/g, preferably 18-22 m²/g, and preferably 19-21 m²/g. In a specific embodiment, the treated material has a specific surface area of 20±4 m²/g. In some embodiments, the treated material has a cumulative pore volume in a range of 0.05-0.06 cubic centimeter per gram (cm³/g), preferably 0.051-0.059 cm³/g, preferably 0.052-0.058 cm³/g, preferably 0.053-0.057 cm³/g, and preferably 0.054-0.056 cm³/g. In a specific embodiment, the treated material has a cumulative pore volume of 0.0540±0.002 cm³/g. Other ranges are also possible.

At step 84, the method 80 includes dispersing the treated material in water and sonicating it to form a dispersion. The water may be tap water, distilled water, bidistilled water, deionized water, deionized distilled water, reverse osmosis water, and/or some other water. In a specific embodiment, the water is deionized water. In some embodiments, modes of agitation other than sonication known to those of ordinary skill in the art, for example, via stirring, swirling, mixing, or a combination thereof may be employed to form the resultant mixture.

At step 86, the method 80 includes mixing the dispersion, a Ni salt, and an alkaline solution to form a slurry and heating the slurry to form a crude product suspended in the slurry. In some embodiments, the Ni salt includes nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate. In a specific embodiment, the Ni salt includes nickel nitrate hexahydrate. In some embodiments, the alkali solution includes at least one alkali salt selected from the group consisting of potassium hydroxide (KOH), sodium hydroxide (NaOH), calcium hydroxide (Ca(OH)₂), potassium carbonate (K₂CO₃), sodium carbonate (Na₂CO₃), and calcium carbonate (Ca₂CO₃). In a specific embodiment, the alkali solution includes a mixture of KOH and K₂CO₃ solution. The mixing may be carried out manually or with the help of a stirrer. The heating can be done by using heating appliances such as hot plates, heating mantles ovens, microwaves, autoclaves, and tapes, oil baths, salt baths, sand baths, air baths, hot-tube furnaces, and hot-air guns.

At step 88, the method 80 includes removing the crude product from the slurry, washing, and calcining at a temperature of about 550° C. to form the Ni-SMR catalyst. The removal of crude product can be done by filtration or centrifugation. The washing of the slurry may be done by using a solvent like water, alcohol, or a mixture thereof. The water may be tap water, distilled water, bidistilled water, deionized water, deionized distilled water, reverse osmosis water, and/or some other water. In a specific embodiment, the washing of the slurry is done by deionized water. Typically, the calcination is carried out in a furnace preferably equipped with a temperature control system, which may provide a heating rate of up to 50° C./min, preferably up to 40° C./min, preferably up to 30° C./min, preferably up to 20° C./min, preferably up to 10° C./min, preferably up to 5° C./min. In some embodiments, the product is heated to a temperature range of 500-600° C., preferably 510-590° C., preferably 520-580° C., preferably 530-570° C., and preferably 540-560° C., for 3-6 h, preferably 3.5-5.5 h, preferably 4-5 h. In a specific embodiment, the product is heated to a temperature of 550° C. for 5 h. Other ranges are also possible.

The crystalline structures of various Ni-SMR catalysts, and the industrial waste solid material (SMR), may be characterized by X-ray diffraction (XRD). The XRD patterns are collected in a Rigaku diffractometer equipped with a Cu-Kα radiation source (X=0.15406 nm) for a 20 range extending between 5 and 100°, preferably 15 and 80°, further preferably 30 and 60° at an angular rate of 0.005 to 0.04° s⁻¹, preferably 0.01 to 0.03° s⁻¹, or even preferably 0.02° s⁻¹.

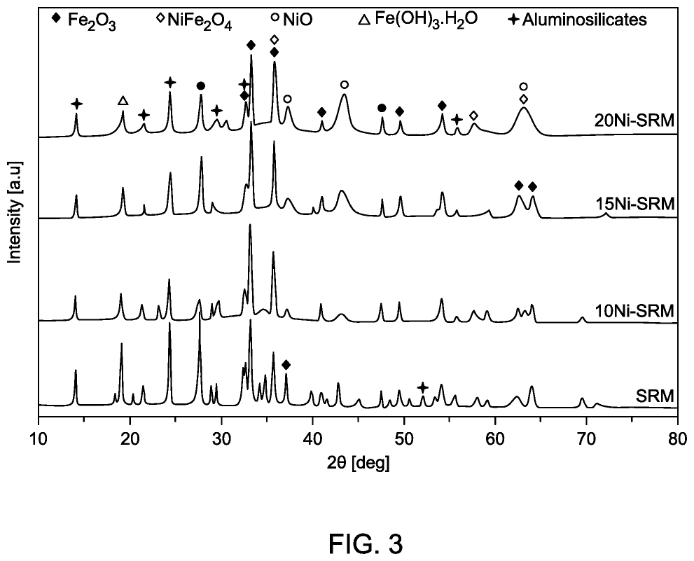

Referring to FIG. 3, XRD profiles for Ni-SMR catalysts prepared with different Ni loadings. In some embodiments, the Ni-SMR catalyst has peaks with a 2 theta (0) value in a range of 31.5 to 33.5°, preferably about 32.5°; 34.5 to 36.5°, preferably about 35.5°; 40 to 42°, preferably about 41°; 48.5 to 50.5°, preferably about 49.5°; 53.5 to 55.5°, preferably about 54.5°; 62 to 64°, preferably about 63°; and 63.5 to 65.5°, preferably about 64.5°, that may be attributed to the hematite phase i.e., α-Fe₂O₃. In some embodiments, the Ni-SMR catalyst has peaks with a 20 value in a range of 26.5 to 28.5°, preferably about 27.5°; and 46.6 to 48.6°, preferably about 47.6°, that may be attributed to TiO₂. In some embodiments, the Ni-SMR catalyst has peaks with a 20 value in a range of 13 to 15°, preferably about 14°; 21 to 23°, preferably about 22°; 27 to 29°, preferably about 28°; 31.5 to 33.5°, preferably about 32.5°; 51 to 53°, preferably about 52°, that may be attributed to aluminosilicates of sodium and calcium. In some embodiments, the Ni-SMR catalyst has peaks with a 20 value in a range of 18 to 20°, preferably about 19° that may be attributed to iron hydroxide hydrate (Fe(OH)₃·H₂O). In some embodiments, the Ni-SMR catalyst has peaks with a 20 value in a range of 35 to 38°, preferably about 36.5°; 38 to 40°, preferably about 38.5°; 40 to 45°, preferably about 42.5°; 55 to 60°, preferably about 57.5°; 60 to 68°, preferably about 64°, that may be attributed to nickel species, e.g., nickel oxide (NiO) and NiFe₂O₄, as depicted in FIG. 3. Other ranges are also possible.

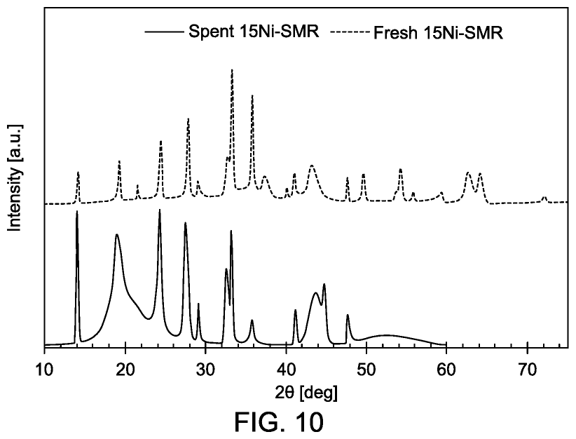

Referring to FIG. 10, XRD profiles of fresh and spent Ni-SMR catalyst. The spent Ni-SMR catalyst shows substantially similar peaks with a 20 value in a range of 31.5 to 33.5°, preferably about 32.5°; 34.5 to 36.5°, preferably about 35.5°; 40 to 42°, preferably about 41°; 48.5 to 50.5°, preferably about 49.5°; 53.5 to 55.5°, preferably about 54.5°; 62 to 64°, preferably about 63°; and 63.5 to 65.5°, preferably about 64.5°, attributed to iron species. The spent Ni-SMR catalyst shows substantially similar peaks with a 20 value in a range of 26.5 to 28.5°, preferably about 27.5°; and 46.6 to 48.6°, preferably about 47.6°, attributed to TiO₂. The spent Ni-SMR catalyst shows substantially similar peaks with a 20 value in a range of 13 to 15°, preferably about 14°; 21 to 23°, preferably about 22°; 27 to 29°, preferably about 28°; 31.5 to 33.5°, preferably about 32.5°; 51 to 53°, preferably about 52°, attributed to aluminosilicates of sodium and calcium. The spent Ni-SMR catalyst shows substantially similar peaks with a 20 value in a range of 18 to 20°, preferably about 19° attributed to iron hydroxide hydrate. The spent Ni-SMR catalyst shows substantially similar peaks with a 20 value in a range of 35 to 38°, preferably about 36.5°; 38 to 40°, preferably about 38.5°; 40 to 45°, preferably about 42.5°; 55 to 60°, preferably about 57.5°; 60 to 68°, preferably about 64°, attributed to nickel species as depicted in FIG. 10. Other ranges are also possible.

The XRD analysis of the Ni-SMR catalyst showed that iron oxide is the primary component of SMR with the ability to catalyze the ammonia decomposition reaction. The reducibility, metal support interaction, and catalytic activity of the catalysts were correlated by the reduction kinetics of the catalyst's H₂-temperature-programmed reduction (TPR) data and nucleation/nuclei growth models. The catalyst reduction may be associated with the random nucleation model. The activation energy for the reduction of the SMR is higher (e.g., preferably about 108.5 kJ/mol) than that of 10Ni-SMR catalysts (e.g., preferably about 86.6 kJ/mol). The increase of nickel loading also decreases the activation energy of catalyst reduction, showing improved reducibility of the nickel-containing catalysts. These reduction behaviors are also examined in the ammonia decomposition reaction in a flow reactor. The addition of nickel, onto the SMR resulted in the creation of additional active nickel oxide species. Consequently, the nickel-loaded SMR catalysts exhibited improvements in ammonia decomposition activity. In some embodiments, the Ni-SMR catalyst showed the improved activity, which was consistent in an extended period of reactions, showing the catalyst stability, which was further confirmed by comparing the XRD patterns of the fresh and spent catalyst.

### Examples

The following examples demonstrate the method for the ammonia (NH₃) decomposition to the hydrogen (H₂) and the nitrogen (N₂). The examples are provided solely for illustration and are not to be construed as limitations of the present disclosure, as many variations thereof are possible without departing from the spirit and scope of the present disclosure.

### Example 1: Materials and Catalyst Preparation

The catalysts were prepared by depositing nickel on the pretreated industrial solid waste material (named SMR), which mainly contains Fe₂O₃ (e.g., preferably about 50%), Al₂O₃ (e.g., preferably about 20%), SiO₂ (e.g., preferably about 20%), and remaining CaO/Na₂O, each % based on a total weight of the SMR. Before nickel loading, the support material was treated and calcined at 800° C. The specific surface area of the calcined support was 20±4 m²/g with pore volume of 0.0540±0.002 cm³/g. In catalyst preparation, the required amount of calcined SMR was dissolved in 10 ml of deionized water. A solution consisting of KOH and K₂CO₃ was prepared. Next, the required amount of nickel nitrate hexahydrate solution was added to about 6 g of SMR that was previously sonicated for 20 minutes. Following this, the KOH and K₂CO₃ solution was added. The final mixture was heated at 80° C. for 1 h under mixing. Then, the slurry was transferred to an oven and heated for another hour. The solid material was separated and washed with water. Finally, the material was calcined at 550° C. for 5 h. The same procedure was followed to prepare catalysts with different Ni content.

### Example 2: Catalyst Characterization

Rigaku diffractometer (manufactured by Rigaku, Japan) with Cu Kα radiation operating at 15 mA and 40 kV was utilized to evaluate X-ray diffraction (XRD) profiles of fresh and spent catalyst samples. In addition, a step size of 0.02 within a scanning range between 10 and 90 two theta degrees (20°) were set. X'pert software was used for phase identification. Auto Chem II 2920, a product of Micromeritics USA, was used to study the reduction profiles and reduction/activation kinetics using H₂-temperature-programmed reduction (TPR) technique. Approximately 70 mg of the catalyst sample was initially pretreated at 150° C. to remove any impurities over the surface of the catalyst and subsequently cooled to room temperature prior to a heat treatment where the temperature is raised up to 900° C. at a ramp rate of 10° C./min under a reductive environment of 10% H₂/Ar mixture gas flowing at 30 mL/min.

### Example 3: Catalyst Activity

A fixed-bed stainless steel tubular reactor (FIG. 2) is used in the process to carry out the catalytic decomposition of ammonia. The reactor is packed with 0.2 grams of catalyst and has an inner diameter of 0.5 inches and a length of 11 inches. The decomposition process takes place at atmospheric pressure, with a quartz wool plug positioned below the catalyst. Monitoring of the reactor's temperature is achieved by placing a K-type thermocouple axially at the center of the catalyst bed. Before initiating the reaction, the catalyst undergoes a reduction process. At 700° C., it is exposed to a flow of hydrogen gas (H₂) at a rate of 30 ml/min for a duration of 20 minutes, with ramping rate of 1° C. per minute. Following this, any remaining hydrogen gas is purged using helium gas (He) to remove traces of H₂. The reactor temperature is subsequently set to the targeted study condition under a continuous flow of helium. For the reaction, a diluted mixture of ammonia (NH₃) with a concentration of 10% vol is introduced into the catalyst bed, balanced with helium gas (He). The mixture flows through the catalyst bed at a rate of 20 ml/min, corresponding to an equivalent space velocity of 6000 ml/g_{cat}/hr. The conversion of NH₃ is measured once the system reaches a steady state, typically after 15 minutes of operation.

To quantify the amount of NH₃, an Agilent 7890B gas chromatograph equipped, GC, with a thermal conductivity detector is employed. The GC utilizes an HP-PLOT U column with dimensions of 30 meters in length and 0.32 mm inner diameter. The GC analysis is conducted under isothermal conditions at a temperature of 50° C., with helium gas serving as the carrier gas to analyze the composition of the output gas. The expression for NH₃ conversion is determined based on these experimental observations and measurements:

$${NH}_{3} conversion = \frac{{NH}_{3 , in} - {NH}_{3 , out}}{{NH}_{3 , in}} \times 100 \% \qquad ( 1 )$$

### Example 4: X-Ray Diffraction (XRD) Analysis

The crystallographic data using XRD of various nickel-based catalysts supported on SMR are presented in FIG. 3. It can be seen that XRD patterns demonstrate a range of diffraction peaks that can be a measure of SMR components. The XRD profiles of sole SMR exhibit patterns at 32.5, 35.5, 41, 49.5, 54.5, 63, and 64.5° that are attributed to the hematite phase i.e., α-Fe₂O₃, while representative peaks at 27.5 and 47.6° belong to TiO₂ [See: D. Wang, D. Wang, J. Yu, Z. Chen, Y. Li, S. Gao, Role of alkali sodium on the catalytic performance of red mud during coal pyrolysis, Fuel Processing Technology. 186 (2019) 81-87; J. X Qian, L. R. Enakonda, W. J Wang, D. Gary, P. Del-Gallo, J. M. Basset, D. Bin Liu, L. Zhou, Optimization of a fluidized bed reactor for methane decomposition over Fe Al₂O₃catalysts: Activity and regeneration studies, Int J Hydrogen Energy. 44 (2019) 31700-31711; and L. Zhou, L. R. Enakonda, M Harb, Y. Saih, A. Aguilar-Tapia, S. Ould-Chikh, J. louis Hazemann, J Li, N. Wei, D. Gary, P. Del-Gallo, J. M. Basset, Fe catalysts for methane decomposition to produce hydrogen and carbon nano materials, Appl Catal B. 208 (2017) 44-59, each of which is incorporated herein by reference in their entireties]. The peaks at 14, 22, 28, 32.5, and 52° are ascribed to aluminosilicates of sodium and calcium, respectively. The existence of a diffraction peak at 19° is associated with iron hydroxide hydrate (Fe(OH)₃·H₂O). For nickel-based catalysts, additional diffraction peaks are observed, which are associated with nickel oxide (NiO) and NiFe₂O₄[See: S. Lin, Z. Gu, X Zhu, Y. Wei, Y. Long, K. Yang, F. He, H. Wang, K. Li, Synergy of red mud oxygen carrier with MgO and NiO for enhanced chemical-looping combustion, Energy. 197 (2020), which is incorporated herein by reference in its entirety]. It also can be seen that the addition of nickel may influence the peaks of hematite and starts to disappear at higher nickel loadings.

### Example 4: Temperature-Programmed Reduction Analysis

Temperature-programmed reduction using hydrogen as probe gas (H₂-TPR) is a technique to measure the number of reducible species as well as the metal-support interaction that play a role in influencing the catalytic performance of as-synthesized catalysts. The reduction profiles of SMR-supported nickel-based catalysts are shown in FIG. 4. It also can be seen that the reduction profile of the pure SMR indicates two peaks. Earlier, XRD data revealed that the major component of SMR with reducible species is hematite (α-Fe₂O₃), hence, the two peaks can be assigned to the two-step reduction of hematite species. Therefore, the medium-temperature peak, ranging from 400 to 740° C., could be assigned to the reduction of isolated Fe₂O₃ to Fe₃O₄, while the reduction peak at higher temperature (740-900° C.) could be due to the reduction of Fe₃O₄ to FeO/Fe [See: R. Huang, H. Fukanuma, Y. Uesugi, Y. Tanaka, Comparisons of two models for the simulation of a DC arc plasma torch, in: Journal of Thermal Spray Technology, 2013: pp. 183-191; and A. Cabello, C. Dueso, F. Garcia-Labiano, P. Gaydn, A. Abad, L. F. De Diego, J Addnez, Performance of a highly reactive impregnated Fe₂O₃/Al₂O₃ oxygen carrier with CH₄ and H₂S in a 500 Wth CLC unit, Fuel. 121 (2014) 117-125, each of which is incorporated herein by reference in their entireties]. The doping of nickel over the SMR has an influence on the reduction behavior of the supported catalysts. For instance, the catalyst with lower nickel loading of 10 wt % (10Ni-SMR) slightly shifts both of the reduction peak maxima to a lower temperature i.e., medium-temperature peaks shift from 610 to 580° C. and higher temperature peaks shifts from 810 to 790° C., respectively. This shows that nickel doping facilitates the reduction of oxide species; however, the hydrogen uptake for 10Ni-SMR (2.77 mmol/g) is lower than SMR (2.82 mmol/g), indicating loss of a number of reducible species associated with coverage of hematite species with nickel. On the contrary, the catalysts with higher nickel loadings of 15 and 20 wt % (15Ni-SMR and 20Ni-SMR) have demonstrated approximately similar peak maxima as that of SMR in medium-temperature region. However, a peak maxima are shifted from 810 (SMR) to 845° C. (15Ni-SMR) and 840° C. (20Ni-SMR), respectively, in higher temperature regions. This observation shows that higher nickel loadings promote interaction between nickel and hematite, leading to the formation of less reducible spinel nickel ferrites (NiFe₂O₄). Moreover, hydrogen uptakes for 15Ni-SMR (3.33 mmol/g) and 20Ni-SMR (3.40 mmol/g) are also higher than SMR (2.82 mmol/g), showing a higher number of reducible species in these catalysts. It can be concluded that nickel doping at lower loading (10Ni-SMR), though it covers hematite species, facilitates easier reduction of oxide species, while reduction becomes challenging at higher nickel loadings due to the formation of spinel species. Moreover, the major portion of reduction peaks is covered by medium-temperature peaks, it can be seen that this peak would have a major role during the catalytic activity test.

The metal oxide-based solid catalysts are reduced and/or activated using hydrogen as a probe gas, and this reduction/activation (R/A) generally involves multiple steps. These multi-step reactions are not only distinct but also have disparities in comparison with common homogeneous and/or heterogeneous reactions. For instance, the R/A of metal oxide takes place at the solid-solid interface where each solid represents a substrate and a product, respectively [See: M. M. Hossain, S. Ahmed, Cu-based mixed metal oxide catalysts for WGSR: Reduction kinetics and catalytic activity, Canadian Journal of Chemical Engineering. 91 (2013) 1450-1458, which is incorporated herein by reference in its entirety]. There are various effective reduction mechanisms that are largely a function of the types of reducible metal oxides. Hence, diverse reduction models are used to represent the A/R kinetics of solid solutions-based reducible species, bulk metal oxides and/or complexes, and metal-based supported catalysts. The present disclosure demonstrates experiments of temperature programmed reduction (TPR) conducted in a packed bed with the provision of using the reaction system as a differential reactor. The thin bed of the catalyst under chosen operating conditions allows the negligibility of film diffusion. Consequently, the selected operating conditions facilitate the reduction rate to be the key controlling factor during the hydrogen-solid oxide catalyst chemical reaction.

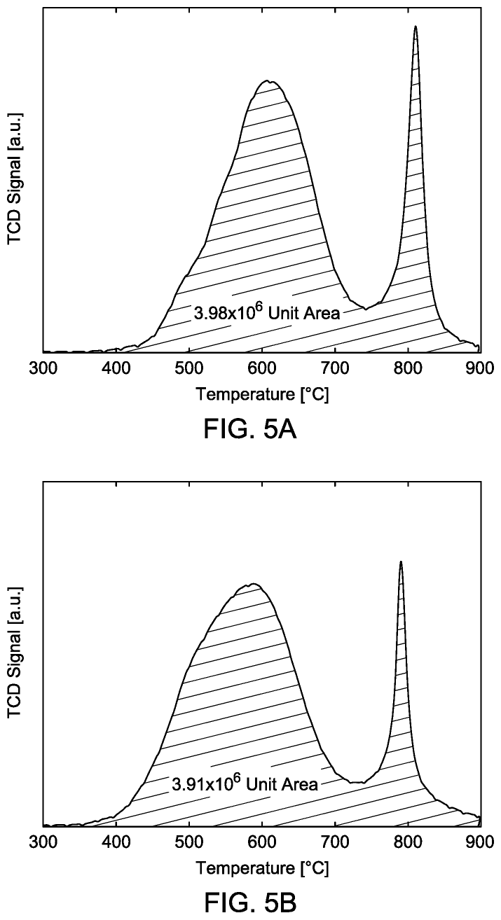

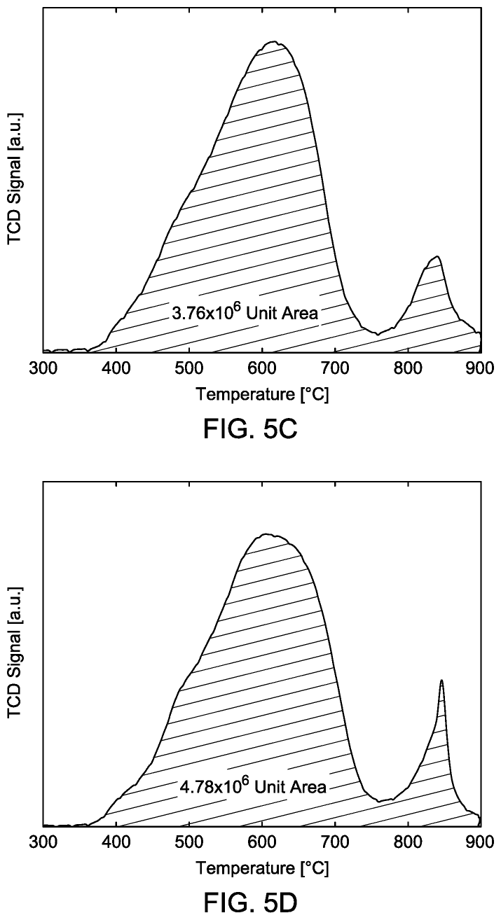

The determination of hydrogen consumption for each peak in the TPR profiles of various catalysts is based on the measurement of the areas under the peaks, as shown in FIGS. 5A-5D. Upon comparison, it becomes evident that the 20Ni-SMR catalyst exhibits the highest hydrogen consumption among the catalysts, while the SMR catalyst also demonstrates a relatively large total area. This quantitative assessment of hydrogen consumption during TPR holds significance due to the direct correlation between the amount of hydrogen consumed and the extent of metal reduction.

The TPR kinetics model data in the case of solid-oxide catalysts is generally expressed in the form of an overall rate of reaction that is dependent upon the degree and/or extent of reduction of solid-oxide catalyst (ƒ(α)) as well as the gas-phase species' composition:

dα(t)/dt=k(T)ƒ(α)ƒ(P_{H2},P_{H2O}) (2)

where, (α) is the reaction progress and its expression is a function of existing measured variable(s). In general, there are various ways to define the extent or degree of reaction such as mass change or variation in gas evolved/consumed or in terms of heat evolved/consumed.

In the present disclosure, TPR hydrogen uptake data is utilized to define the extent of activation/reduction. The reaction associated with solid-state involves transient conversion (α) that is calculated using the equation 3 as,

$$α ( t ) = \frac{Δ {n}_{t}}{Δ {n}_{total}} \qquad ( 3 )$$

where, (Δnₜ) denotes the hydrogen uptake amount (moles) at any time (t) (min) and (Δnₜₒₜₐₗ) is the total hydrogen uptake amount (moles) required to completely reduce the metal oxides of the catalyst.

The constant feed composition and flow rates, along with differential reactor conditions, allow the possibility to ignore the function (ƒ(P_{H2}, P_{H2O})) in equation 2 that can be reduced to equation 4:

$$\frac{d α ( t )}{dt} = K ( T ) f ( α ) \qquad ( 4 )$$

Where well-known Arrhenius equation can facilitate defining the (k(T)), the reaction rate constant, as demonstrated in equation 5,

$$k = {k}_{0} exp [ \frac{- {E}_{a}}{R} ( \frac{1}{T} - \frac{1}{{T}_{m}} ) ] \qquad ( 5 )$$

where, k₀ represents the pre-exponential factor and activation energy is denoted by (Eₐ). The parameter cross-correlation can be minimized by using the centering temperature (Tm). Both activation energy (Eₐ) and pre-exponential factor (k₀) require separation of functions i.e., k(T) and ƒ(α) in equation 4, for their evaluation. Among these functions, ƒ(a) is merely dependent upon the kinetic model utilized for rate expression measurement. The kinetic models include mechanistic and empirical models. The complexity of overall reduction reaction is described herein. The following sequential steps involved in a metal oxide reduction include [See: M. M. Hossain, H. I. de Lasa, Reduction and oxidation kinetics of Co-Ni Al₂O₃ oxygen carrier involved in a chemical-looping combustion cycles, Chem Eng Sci. 65 (2010) 98-106, which is incorporated herein by reference in its entirety];
a) molecular hydrogen dissociation that initiates within induction period where metal oxide is mainly responsible for dissociation and this molecular hydrogen dissociation gets promoted during grain growth resulting from earlier reduced metals (initially by metal oxide during the induction period, then by previously formed metals as the reduction front advances into the grain),
b) dissociated hydrogen atoms diffuse through surface to reach a reduction center,
c) bond estrangement of metal oxide,
d) formation of metallic cluster as a result of metal atoms nucleation, and
e) metal clusters formed grow further to develop metal crystallites.

The reduction reaction rate is a function of (one or more of) these sequential steps. The reduction reaction rate in case of a heterogeneous catalyst can be influenced by metal oxide grains availability. Similarly, the accessibility of oxide sites is a function of not only the pore size distribution of the catalyst but also the size and shape of the metal crystallites. The intrinsic chemical characteristics of the oxide support, in a heterogeneous catalyst system, have impact on the desired alignment of the active component that plays a role in affecting the catalyst reducibility [See: J. T. Richardson, R. M. Scates, M. V. Twigg, X-ray diffraction study of the hydrogen reduction of NiO α-Al 2O3 steam reforming catalysts, Appl Catal A Gen. 267 (2004) 35-46; and J. T. Richardson, R. Scates, M. V Twigg, X-ray diffraction study of nickel oxide reduction by hydrogen, Appl Catal A Gen. 246 (2003) 137-150, which is incorporated herein by reference in its entirety]. A gas-solid reaction kinetics are elaborated in a series of alternative kinetic models [See: B. Michael, Introduction to thermal analysis, techniques and applications, Thermochim Acta. 155 (2004)]. The extent of reduction conversion (a) versus time on stream (t) profile (α(t)) provides the basis for selecting the gas-solid reaction kinetics model. The multistep gas-solid reduction reaction is indicated by (S-)shape of α(t) profile during H₂-TPR of the catalyst. These steps include nuclei establishment and subsequent growth, aggregation and/or agglomeration, displacement, and point defection. In the present disclosure, parameters associated with solid-state kinetic model are examined by utilizing random nucleation kinetic model, power law model, Avrami-Erofeev models (AEM), two and three dimensional AEM as shown in Table 1.

TABLE 1
Models investigated for f(α)

| No. | Mechanism | Model formulation |
|---|---|---|
| 1. | Power law model | f(α) = (1 − α)ⁿ |
| 2. | Avrami-Erofeev model | f(α) = n(1 − α)[−ln(1 − α)]^{(n-1)/n} |
| 3. | Random nucleation | f(α) = 1 − α |
| 4. | 2-dimensional nuclei growth | f(α) = 2(1 − α)[−ln(1 − α)]^{1/2} |
| | (2D Avrami-Erofeev model) | |
| 5. | 3-dimensional nuclei growth | f(α) = 3(1 − α)[−ln(1 − α)]^{2/3} |
| | (3D Avrami-Erofeev model) | |

The experimental data points within reduction conversion of 0 and 1 (0<α<1 of equation 4 and 5) were numerically fitted and ƒ(α) expressions from Table 1 corresponding to random nucleation model and nuclei growth model were least square fitted in a MATLAB program, to estimate the kinetic parameters including activation energy (Eₐ), pre-exponential factor (k₀), and order of reaction (n). The reproducibility of TPR generated reduction data was very high and standard deviations of multiple repetitions of the experiments remained 1.1%. The parametric analysis was conducted at a confidence limit of 95% and parametric estimation was based on one thousand data points taken in each experimental case leading to a higher degree of freedom i.e., more than 997 (difference of 1000 data points and 3 parameters required to be estimated). This indicates that significant number of experimental data points were measured for model parameter iteration that facilitates accurate model predictions.

During the implementation of various models, smaller SSQ residual, lower discrete confidence intervals, and correlation or determination coefficient (R²), are utilized to discriminate within models. AEM with n=1, exhibited relatively better curve fitting based on parameter spans and values of correlation coefficient i.e., R². Among models in Table 1, RN model with n=1, was chosen because no variation in crystallite size was assumed during recurrent reduction/oxidation cycles (manifesting close to constant crystallite size hypothesis) showing restricted growth of crystallites within cycles. The reduced values of R² and SSQ as well as increased spans from 2-5% to 10-20% at higher n values e.g., n=2, indicate that in comparison with 2D AEM, RN model remains more favorable.

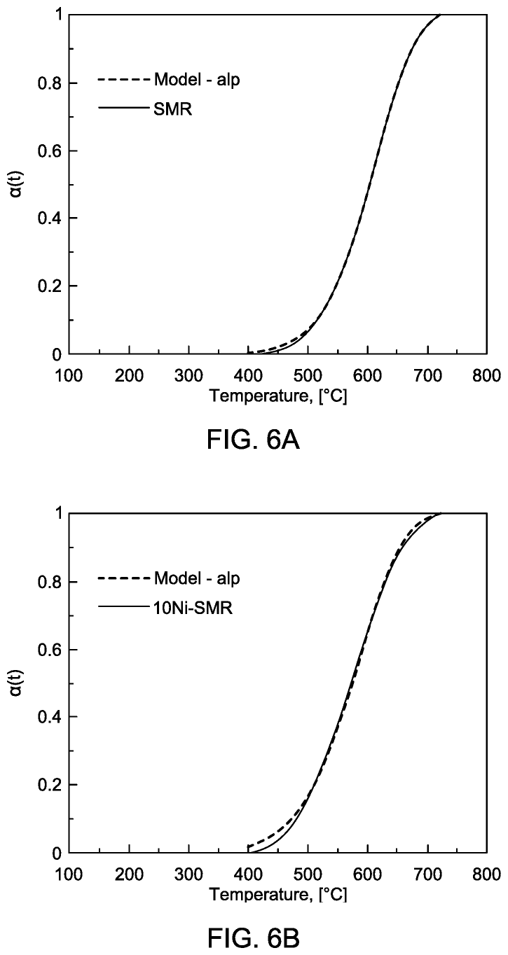

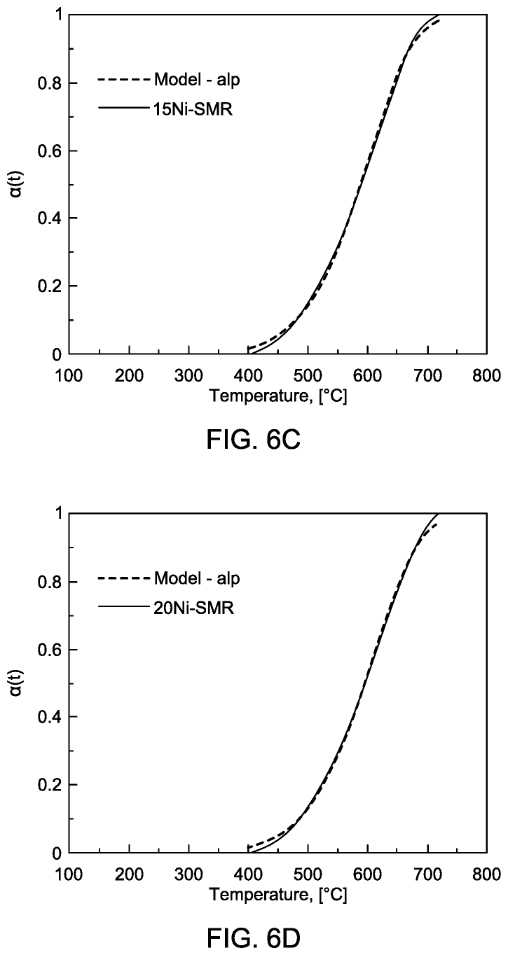

FIGS. 6A-6D compares the experimentally evaluated reduction reaction conversions with predicted conversions based on RN model for all the catalysts investigated in the present disclosure. This comparison of experimental data with predicted data based on model shows residual normal distribution with higher correlation coefficients.

All the estimated parameters with their corresponding values within confidence interval of 95% along with determination and cross-correlation coefficients for all the catalysts are given in Table 2. The activation energy data in Table 2 shows that the activation energy values for industrial waste is relatively higher than nickel-based supported catalysts and all the samples have shown an activation energy within the range of 80 and 110 kJ/mol. The earlier studies on metal-oxide reduction kinetics have shown that controlled reduction rate regimes define three groups based on the activation energies [See: P. H. Bolt, -F H P M Habraken, J. W. Geus, Formation of Nickel, Cobalt, Copper, and Iron Aluminates from a- and c-Alumina-Supported Oxides: A Comparative Study, 1998, which is incorporated herein by reference in its entirety]. For instance, the activation energies within 15-25 kJ/mol represents the first group where overall reduction reaction is restricted largely associated with resistance emerging from external or stronger pore diffusion. The controlled reduction regime linked with pore diffusion defines the second group where activation energies lie within 40 and 50 kJ/mol. Lastly, the controlled reduction based on chemical reaction defines the third group where activation energies are higher than 65 kJ/mol. It also can be seen from the data in Table 2 that industrial waste-based support as well as supported catalysts (10Ni-SRM, 15Ni-SRM, and 20Ni-SRM) are represented by third group ascribed to controlled chemical reaction-based reduction in agreement with the assumption of no mass transport limitations.

TABLE 2
Estimated model parameters for non-isothermal
reduction of the catalyst samples.

| Catalyst Sample | k0 × 104 | E (kJ/mol) | R2 | γ* |
|---|---|---|---|---|
| SMR | 48.0 ± 0.067 | 108.5 ± 0.115 | 0.9998 | −0.8527 |
| 10Ni-SMR | 91.0 ± 0.017 | 86.6 ± 0.188 | 0.9988 | −0.6288 |
| 15Ni-SMR | 73.0 ± 0.016 | 84.2 ± 0.143 | 0.9992 | −0.7385 |
| 20Ni-SMR | 67.0 ± 0.011 | 83.4 ± 0.132 | 0.9991 | −0.7740 |

Note:
Repeats displayed a typical ±2.2% standard deviation; γ*: Cross correlation coefficient

The comparison of reduction activation energies of all the catalysts shows that the nickel loaded catalyst samples showed decreased values of activation energies than the SMR support/catalyst itself. The similar SMR composition in all the catalyst samples demonstrates the promotional impact of nickel doping leading to the lower values of activation energy for supported nickel catalysts. These results are in line with enhanced hydrogen uptake depicted by supported nickel catalysts observed in H₂-TPR. An enhanced reducibility of nickel species with addition of Co to Ni leading to higher metal dispersion even in a low specific surface area sample is observed [See: M. M. Hossain, H. L. de Lasa, Reactivity and stability of Co-Ni Al₂O₃ oxygen carrier in multicycle CLC, AIChE Journal. 53 (2007) 1817-1829]. In a similar case, a second metal incorporation facilitates higher reducibility of the mixed oxide catalysts by reducing the metal support interactions and/or in some cases acting as a barrier phase that prevents the formation of non-reducible metal oxide species [See: M. M. Hossain, H. L. de Lasa, Reduction and oxidation kinetics of Co-Ni Al₂O₃ oxygen carrier involved in a chemical-looping combustion cycles, Chem Eng Sci. 65 (2010) 98-106].

Among the three supported nickel catalysts (Ni-SRM), the highest nickel containing catalyst i.e., 20Ni-SMR demonstrated the less value of activation energy, as shown in Table 2. This least value of activation energy for 20Ni-SRM is ascribed to smaller number of metal-to-metal local interactions as well as localized interaction of metal with neighboring oxide species [See: M. M. Hossain, H. L. de Lasa, Reactivity and stability of Co-Ni/Al₂O₃ oxygen carrier in multicycle CLC, AIChE Journal. 53 (2007) 1817-1829; and B. Malecka, E. Drozdz-Ciesla, A. Malecki, Mechanism and kinetics of thermal decomposition of zinc oxalate, Thermochim Acta. 423 (2004) 13-18, each of which is incorporated herein by reference in their entireties]. Several elucidations focused on discussing the reduction nature of nickel-based catalysts are described, for example, alumina supported nickel-based catalysts for methane reforming [See: J. M Rynkowski, T. Paryjczak, M. Lenik, On the nature of oxidic nickel phases in NiO y-Al 20a catalysts 73, 1993]. The catalyst characterization results such as XRD showed the formation of nickel oxide (NiO) species as well as spinel species i.e., NiAl₂O₄. TPR analysis revealed that reducibility of each oxide i.e., NiO and NiAl₂O₄ varies and amorphous NiO easily reduced within temperature range of 380 and 690° C. while a higher temperature of 780° C. is required to reduce NiAl₂O₄. In another case, an alumina supported Ni-based oxygen carriers were synthesized for their application in CLC. The diffraction data exhibited formation of stable spinel species (NiAl₂O₄) leading to reduced amount of oxide species resulting in decreased reduction conversion [See: H. Jin, T Okamoto, M. Ishida, Development of a Novel Chemical-Looping Combustion: Synthesis of a Looping Material with a Double Metal Oxide of CoO—NiO, Energy & Fuels. 12 (1998) 1272-1277].

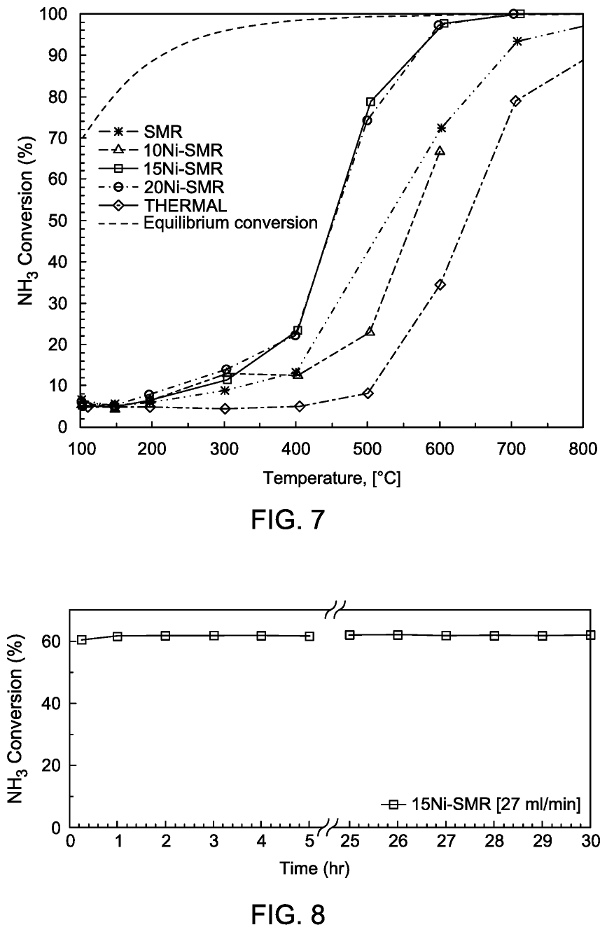

The catalytic activities of the prepared Ni-SMR catalysts for NH₃ decomposition are conducted by systematically varying the reaction temperature. The resulting data, presented in FIG. 7, shows the analysis of the temperature dependence on catalytic performance. In order to account for thermodynamic influences, the thermodynamic equilibrium was determined using Aspen Plus software, employing Ping Robinson equation of state. By incorporating this equilibrium data into the analysis, the system's behavior was demonstrated.

Moreover, an analysis was conducted to assess the catalytic performance of the support, SMR, in comparison to the Ni-SMR catalyst with deferent Ni loading. This analysis enables a more comprehensive evaluation of the catalytic system's efficiency and effectiveness, imparting valuable insights for catalyst optimization. Additionally, by examining the system without catalyst loading, the thermal characteristics and overall performance of the system are demonstrated. This understanding contributes to a more comprehensive understanding of the system's behavior and aids in the refinement and optimization of catalyst designs.

The data shown in the present disclosure demonstrates that elevating the catalytic reaction temperature in the catalyst bed may lead to notable enhancements in ammonia conversions for all catalysts. This observed trend shows an intensified decomposition rate at higher temperatures, emphasizing the catalytic system's ability to promote efficient ammonia decomposition. This data also shows the system's intrinsic thermal characteristics, and examined the overall process dynamics related to the design and optimization of ammonia decomposition systems.

The catalyst that exhibits the improved performance, e.g., the 15Ni-SMR catalyst, primarily was attributed to its utilization of a lower amount of active metal. Using a lower amount of active metal in the ammonia decomposition reaction offers several advantages. Firstly, it allows for more efficient utilization of the catalyst material. By reducing the active metal loading, the catalyst can be distributed more evenly and maximize the exposure of active sites to the reactants. This improved accessibility enhances the catalytic activity and promotes higher conversion rates. Moreover, employing a lower amount of active metal can mitigate potential issues such as catalyst deactivation. Metal sintering or agglomeration, which can lead to a decline in catalytic performance over time, can be minimized by reducing the metal loading. Furthermore, using a smaller amount of active metal can also provide economic benefits. Active metals are often costly, and reducing their usage without compromising performance can lead to significant cost savings in large-scale industrial applications.

Extensive long-term stability tests were conducted on the Ni-SMR catalysts, specifically the 15Ni-SMR catalyst, as depicted in FIG. 8. These tests showed no signs of deactivation over a minimum duration of 30 hours under the specified reaction conditions. This stability demonstrates that the chosen catalyst, 15Ni-SMR, has improved thermal resilience, surpassing that of other SMR-based catalysts and certain Ru-based catalysts [See: S. F. Kurtoglu, A. Uzun, Red Mud as an Efficient, Stable, and Cost-Free Catalyst for COx-Free Hydrogen Production from Ammonia, Sci Rep. 6 (2016), each of which is incorporated herein by reference in its entirety].

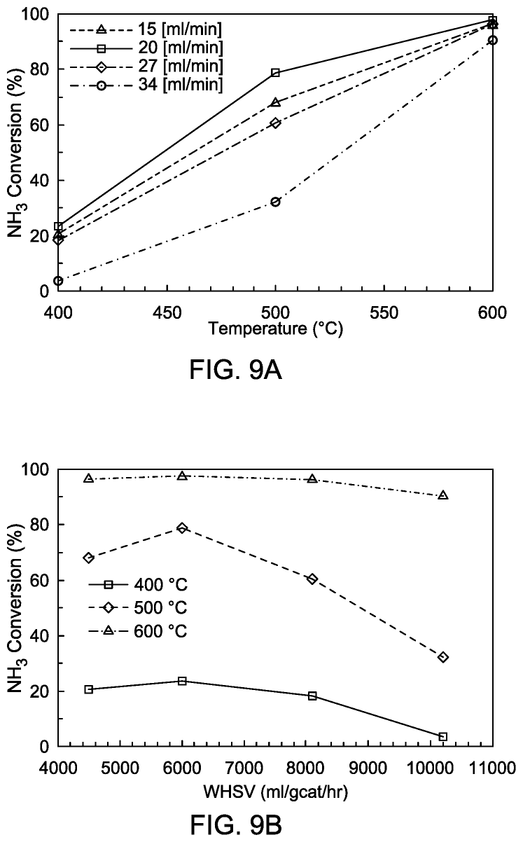

The influence of temperature on ammonia conversion was examined on the Ni-SMR catalysts, specifically the 15Ni-SMR catalysts under different NH₃ flow rates, including 15, 20, 27, and 34 ml/min. The experiments were conducted at a constant pressure of 1 atm, with a fixed catalyst weight of 0.2 g. The results of the present disclosure, depicting the relationship between temperature and ammonia conversion, can be found in FIG. 9A. In FIG. 9B, the impact of WHSV on ammonia conversions at temperatures of 400° C., 500° C., and 600° C. is presented for the 15Ni-SMR catalyst. The WHSV values were obtained by varying the ammonia inlet flow rates to 15, 17, 20, and 27 mL/min, while maintaining a constant catalyst load (0.2 g for all flow rates, except for 17 mL/min where it was 0.1 g).

The results show that at 600° C., ammonia conversions exceeding 95% are achieved for WHSV values ranging from 4,500 to 8,100 mL/g_{cat}/h, indicating an improved conversion of ammonia into hydrogen. However, as the reaction temperature is lowered to 500° C., the ammonia conversion may decrease with the increasing of WHSV. This shows the influence of WHSV on the performance of ammonia decomposition, particularly at temperatures below 500° C. The decrease in ammonia conversion at 500° C. can be attributed to the shorter residence time resulting from higher WHSV values.

The decline in conversion efficiency at lower temperatures with increased WHSV is primarily attributed to the limited time available for the ammonia molecules to interact with the catalyst surface. As the WHSV rises, the gas flow rate through the catalyst bed increases, resulting in shorter residence times. This reduced residence time hinders the utilization of the catalyst's active sites and limits the extent of ammonia decomposition. Control of WHSV is essential for optimizing the performance of ammonia decomposition processes. A balanced WHSV ensures an adequate residence time, allowing sufficient interaction between the ammonia and the catalyst surface, thus promoting higher conversion rates. By precisely controlling WHSV within an optimal range, the efficiency and selectivity of the ammonia decomposition reaction can be enhanced, leading to improved overall process performance and hydrogen production. Thus, WHSV serves as a crucial operational parameter that should be carefully considered in designing and optimizing ammonia decomposition systems.

The reducibility or extent of reduction and metal-support interaction are known for their role in controlling the catalytic activity performance during ammonia decomposition [See: W. U. Khan, H. S. Alasiri, S. A. Ali, M. M Hossain, Recent Advances in Bimetallic Catalysts for Hydrogen Production from Ammonia, The Chemical Record. 22 (2022)]. The activity performance results in FIG. 7 can be correlated and discussed with respect to the reduction kinetics. The increase in nickel amount in modified industrial waste support reduced the amount of activation energy required for R/A of these catalysts that in turn influences the ammonia conversion as shown in FIG. 7. It can be seen that the catalyst with higher nickel amounts, i.e., 15Ni-SMR and 20Ni-SMR with comparable reduction activation energies have demonstrated similar trend in activity performance. The nickel modification leading to enhanced reducibility manifested by improved catalytic activity. For instance, iron-based catalysts for ammonia decomposition reaction and revealed that nickel modification of iron has significantly affected the reduction profile of iron-based catalysts that also had an impact on the catalytic activity of the resulting catalysts [See: S.-Q. SUN, Y.-H. YI, L. WANG, J.-L. ZHANG, H.-C. GUO, Preparation and Performance of Supported Bimetallic Catalysts for Hydrogen Production from Ammonia Decomposition by Plasma Catalysis, Acta Physico-Chimica Sinica. 33 (2017) 1123-1129]. The reduction peaks temperature range for the catalyst with easily reducing species (6Fe-4Ni/SiO2) remained between 30° and 600° C. with de-convoluted peak maxima at approximately about 400 and 480° C., respectively. Hence examining the catalytic performance at 500° C. found that this catalyst showed a stable ammonia conversion for as long as 16 h.

The crystallographic data using XRD of the spent 15Ni-SMR and fresh 15Ni-SMR are compared FIG. 10. XRD profiles of spent catalysts exhibit similar diffraction patterns of fresh catalysts. The XRD peaks at 14, 22, 28, 32.5, and 52° are ascribed to aluminosilicates of sodium and calcium, respectively. The existence of diffraction peak at 19° is associated with iron hydroxide hydrate (Fe(OH)₃·H₂O). The additional diffraction peaks are observed which are associated with nickel oxide (NiO) and NiFe₂O₄[See: S. Lin, Z. Gu, X Zhu, Y. Wei, Y. Long, K. Yang, F. He, H. Wang, K. Li, Synergy of red mud oxygen carrier with MgO and NiO for enhanced chemical-looping combustion, Energy. 197 (2020), which is incorporated herein by reference in its entirety]. These observation shows minimum structural variations in the catalysts were noticed during ammonia decomposition reaction in the flow reactor.

Comparing the activity of the 10Ni-SMR and 15Ni-SMR catalysts to that of existing nickel catalysts supported on metal oxides and Ru-based catalysts supported on modified red mud (MRM), Table 3 shows that these catalysts are comparable to or have higher activity levels. At the same operating temperature and weight hourly space velocity (WHSV) (500° C. and 6000 ml/gcat/hr, respectively), Ni/La₂O₃ achieves a conversion rate of 33% [See: H. Muroyama, C. Saburi, T. Matsui, K. Eguchi, Ammonia decomposition over Ni La 2O 3 catalyst for on-site generation of hydrogen, Appl Catal A Gen. 443-444 (2012) 119-124]. When both variables are held constant. 10Ni-SMR achieves a higher degree of conversion while making use of waste material as its support.

Furthermore, the performance of 15Ni-SMR is excellent, due to the use of a lesser amount of active metal, according to the present disclosure. When compared to Ni-based catalysts on a range of metal oxides at a WHSV of 7500 ml/gcat/hr and temperature of 500° C. [See: I. Lucentini, X Garcia, X Vendrell, J. Llorca, Review of the Decomposition of Ammonia to Generate Hydrogen, Ind Eng Chem Res. 60 (2021) 18560-18611; and S. F. Kurtoglu, S. Soyer-Uzun, A. Uzun, Utilizing red mud modified by simple treatments as a support to disperse ruthenium provides a high and stable performance for COx-free hydrogen production from ammonia, Catal Today. 357 (2020) 425-435], with 5% less Ni loading, it demonstrates a reasonably high conversion rate of 65%.

At 550° C. and WHSV of 6000 ml/gcat/hr [See: K. Okura, K. Miyazaki, H. Muroyama, T Matsui, K. Eguchi, Ammonia decomposition over Ni catalysts supported on perovskite-type oxides for the on-site generation of hydrogen, RSC Adv. 8 (2018) 32102-32110], it ranks among the top three catalysts, albeit with a 7% lower conversion rate. Furthermore, due to its lower nickel loading (<25%), hence cost and structural advantages, the 15Ni-SMR has a considerable competitive advantage.

Moreover, when comparing Ru/modified read mud with 15Ni-SMR at different temperatures (300, 400, and 600° C.), 15Ni-SMR demonstrates its superior performance, primarily due to its nearly half the weight hourly space velocity (WHSV) compared to Ru/modified read mud.

Notwithstanding the gain in hydrogen production from ammonia decomposition that this catalyst offers, it is worth underlining that 15Ni-SMR catalysts make use of industrial waste that is generated in large amounts. Moreover, SMR showcases an exceptionally high level of performance, resulting in substantial advantages for both the economy and the environment.

TABLE 3
Estimated model parameters for non-isothermal reduction of the catalyst samples

| | Ni | | | | |
|---|---|---|---|---|---|
| | loading | WHSV | Temperature | Conversion | |
| Catalyst | [%] | [ml/gcat/hr] | [° C.] | [%] | References |
| 10Ni-SMR | 10 | 6000 | 500 | 22 | Present |
| | | | | | disclosure |
| Ni/Al₂O₃ | 10 | 6000 | 500 | 32 | A |
| Ni/La₂O₃ | 10 | 6000 | 500 | 33 | A |
| Ni/SiO₂ | 10 | 6000 | 500 | 30 | A |
| Ni/MgO | 10 | 6000 | 500 | 21 | A |
| Ni/CeO₂ | 10 | 6000 | 500 | 18 | A |
| Ni/TiO₂ | 10 | 6000 | 500 | 15 | A |
| Ni/ZrO₂ | 10 | 6000 | 500 | 4 | A |
| 15Ni-SMR | 15 | 7500 | 500 | 65 | Present |
| | | | | | disclosure |
| Ni/Al₂O₃ | 20 | 7500 | 500 | 84 | B |
| Ni/Al₂O₃ (Ce | 20 | 7500 | 500 | 83 | B |
| aspromoter) | | | | | |
| Ni/γ-Al₂O₃ | 20 | 7500 | 500 | 27 | C |
| Ni/γ-Al₂O₃(Zr | 20 | 7500 | 500 | 29 | C |
| aspromoter) | | | | | |
| Ni/Zr-doped Al₂O₃ | 20 | 7500 | 500 | 43 | C |
| Ni/Ce—Al₂O₃ | 20 | 7500 | 500 | 53 | B |
| Ni/Sr—Al₂O₄ | 20 | 7500 | 500 | 45 | B |
| Ni/Y—Al₂O₅ | 20 | 7500 | 500 | 43 | B |
| Ni/Zr—Al₂O₆ | 20 | 7500 | 500 | 49 | B |
| 15Ni-SMR | 15 | 6000 | 550 | 87 | Present |
| | | | | | disclosure |
| Ni/Nb₂O₅ | 40 | 6000 | 550 | 34 | D |
| Ni/NaNbO₃ | 40 | 6000 | 550 | 39 | D |
| Ni/KNbO₃ | 40 | 6000 | 550 | 36 | D |
| Ni/Al₂O₃ | 40 | 6000 | 550 | 66 | D |
| Ni/LaAlO₃ | 40 | 6000 | 550 | 76 | D |
| Ni/SmAlO₃ | 40 | 6000 | 550 | 82 | D |
| Ni/GdAIO₃ | 40 | 6000 | 550 | 82 | D |
| Ni/MnO₂ | 40 | 6000 | 550 | 43 | D |
| Ni/CaMnO₃ | 40 | 6000 | 550 | 54 | D |
| Ni/SMRnO₃ | 40 | 6000 | 550 | 49 | D |
| Ni/BaMnO₃ | 40 | 6000 | 550 | 46 | D |
| Ni/TiO₂ | 40 | 6000 | 550 | 30 | D |
| Ni/CaTiO₃ | 40 | 6000 | 550 | 37 | D |
| Ni/SrTiO₃ | 40 | 6000 | 550 | 80 | D |
| Ni/BaTiO₃ | 40 | 6000 | 550 | 75 | D |
| Ni/ZrO₂ | 40 | 6000 | 550 | 27 | D |
| Ni/CaZrO₃ | 40 | 6000 | 550 | 51 | D |
| Ni/SrZrO₃ | 40 | 6000 | 550 | 90 | D |
| Ni/BaZrO₃ | 40 | 6000 | 550 | 94 | D |
| 15Ni-SMR | 15 | 10200 | 400 | 4 | Present |
| | | | | | disclosure |
| 15Ni-SMR | 15 | 10200 | 500 | 32 | Present |
| | | | | | disclosure |
| 15Ni-SMR | 15 | 10200 | 600 | 91 | Present |
| | | | | | disclosure |
| Ru/modified read mud | 5 | 24000 | 400 | 3 | E |
| (MRM-5Ru-R) | | | | | |
| Ru/modified read mud | 5 | 24000 | 500 | 30 | E |
| (MRM-5Ru-R) | | | | | |
| Ru/modified read mud | 5 | 24000 | 600 | 95 | E |
| (MRM-5Ru-R) | | | | | |

Reference A: H. Muroyama, C. Saburi, T. Matsui, K. Eguchi, Ammonia decomposition over Ni/La₂O₃ catalyst for on-site generation of hydrogen, Appl Catal A Gen. 443-444 (2012) 119-124.

Reference B: I. Lucentini, X Garcia, X Vendrell, J. Llorca, Review of the Decomposition of Ammonia to Generate Hydrogen, Ind Eng Chem Res. 60 (2021) 18560-18611.

Reference C: S. Henpraserttae, S. Charojrochkul, W. Klysubun, L. Lawtrakul, P. Toochinda, Reduced Temperature Ammonia Decomposition Using Ni Zr-Doped Al₂O₃Catalyst, Catal Letters. 148 (2018) 1775-1783.

Reference D: K. Okura, K. Miyazaki, H. Muroyama, T. Matsui, K. Eguchi, Ammonia decomposition over Ni catalysts supported on perovskite-type oxides for the on-site generation of hydrogen, RSC Adv. 8 (2018) 32102-32110.

Reference E: S. F. Kurtoǧlu, S. Soyer-Uzun, A. Uzun, Utilizing red mud modified by simple treatments as a support to disperse ruthenium provides a high and stable performance for COx-free hydrogen production from ammonia, Catal Today. 357 (2020) 425-435.

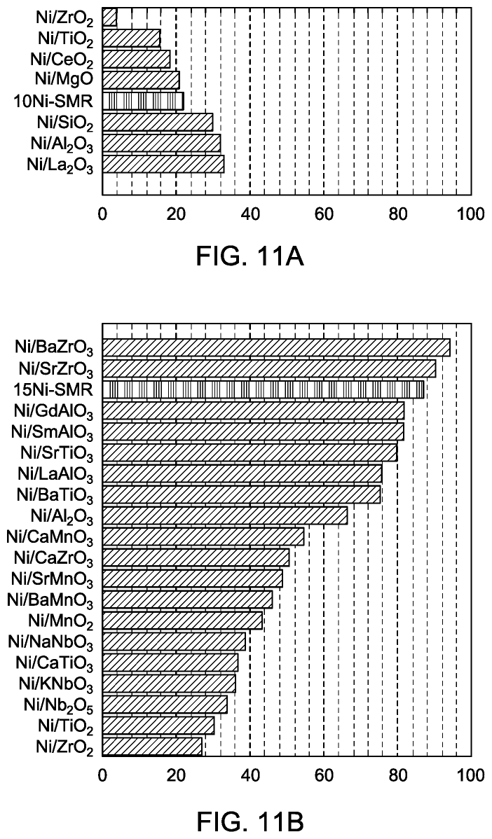

The ammonia conversion (%) obtained by the SMR catalysts in the present disclosure at 500° C. and 550° C. with respect to other Ni-based catalysts are shown graphically in FIG. 11. The Ni-SMR catalyst showed enhanced ammonia decomposition performance. The 15Ni-SMR catalyst distinguishes itself with its improved performance, exhibiting remarkable efficiency in converting ammonia into hydrogen, despite incorporating a considerable amount of active metal in its design. This catalyst exhibits exceptional efficiency, unlocking a range of advantages including optimized resource utilization, cost-effectiveness in catalyst production, enhanced efficiency in hydrogen production via ammonia decomposition, and increased yields in ammonia-derived hydrogen generation. The catalyst design and composition, such as the 15Ni-SMR catalyst, shows the potential for advanced catalyst systems with high performance and favorable economic and environmental outcomes in ammonia decomposition process.

The utilization of industrial waste materials for catalytic applications has garnered attention in the field of chemical engineering. According to the present disclosure, the waste product known as industrial solid waste material (referred to as SMR) generated was investigated for its potential as a catalyst support. The XRD analysis shows that iron oxide is the primary component of SMR which has ability to catalyze the ammonia decomposition reaction. The reduction profiles of SMR have two peaks indicating reduction of hematite species. The lower nickel loading (10Ni-SMR) facilitates easier reduction of oxide species while reduction becomes challenging at higher nickel loadings due to the formation of spinel species. The random nucleation mechanism is found to describe the experimental H₂-TPR data adequately. The estimated activation energy for the reduction of the SMR is higher than that of the nickel containing catalysts, showing improved reducibility of the nickel containing catalysts. The incorporation of nickel onto the SMR resulted in the creation of additional active sites resulting improvements in ammonia decomposition activity. The 15Ni-SMR showed high and stable activity of ammonia decomposition for longer period of time. The activity of the present Ni-SMR catalysts showed improved performance than that of the catalysts reported in the literature. In some embodiments, the 15Ni-SMR catalyst shows the potential for advanced catalyst systems with high performance and favorable economic and environmental outcomes in ammonia decomposition processes, highlighting the importance of catalyst design and composition.

Numerous modifications and variations of the present disclosure are possible in light of the above teachings. It is therefore to be understood that within the scope of the appended claims, the invention may be practiced otherwise than as specifically described herein.

1: A method for ammonia (NH₃) decomposition to hydrogen (H₂) and nitrogen (N₂), comprising:
introducing a H₂-containing feed gas stream into a reactor containing an industrial waste-based nickel (Ni-SMR) catalyst comprising Ni-SMR catalyst particles;
wherein Ni is present in the Ni-SMR catalyst at a concentration of 5 to 30 wt. % based on a total weight of the Ni-SMR catalyst;
passing the H₂-containing feed gas stream through the reactor to contact the H₂-containing feed gas stream with the Ni-SMR catalyst particles at a temperature of 500 to 900° C. to form a reduced Ni-SMR catalyst;
terminating the introducing the H₂-containing feed gas stream;
introducing and passing an NH₃-containing feed gas stream through the reactor to contact the NH₃-containing feed gas stream with the reduced Ni-SMR catalyst at a temperature of 100 to 1000° C. thereby converting at least a portion of the NH₃ to H₂ and regenerating the Ni-SMR catalyst particles to form a regenerated Ni-SMR catalyst, and producing a residue gas stream leaving the reactor;
separating the H₂ from the residue gas stream to generate a H₂-containing product gas stream.

2: The method of claim 1, wherein the Ni-SMR catalyst has a temperature programmed reduction (H₂-TPR) of 2.5 to 3.5 millimoles (mmol) of H₂ per gram of the Ni-SMR catalyst.

3: The method of claim 1, wherein the Ni-SMR catalyst has an activation energy of 80 to 90 kilojoules per mole (kJ/mol).

4: The method of claim 1, wherein the H₂ is present in the H₂-containing feed gas stream at a concentration of 90 to 99.99 vol. % based on a total volume of the H₂-containing feed gas stream.

5: The method of claim 1, wherein the NH₃ is present in the NH₃-containing feed gas stream at a concentration of 5 to 20 vol. % based on a total volume of the NH₃-containing feed gas stream.

6: The method of claim 1, wherein the NH₃-containing feed gas stream further comprises an inert gas selected from the group consisting of nitrogen, argon, and helium, and wherein a volume ratio of the NH₃ to the inert gas present in the NH₃-containing feed gas stream is in a range of 1:4 to 1:20.

7: The method of claim 6, wherein the NH₃-containing feed gas stream further comprises helium, and wherein the residue gas stream leaving the reactor comprises ammonia, nitrogen, helium, and hydrogen.

8: The method of claim 1, wherein the reactor is at least one selected from the group consisting of a fixed-bed reactor, a trickle-bed reactor, a moving bed reactor, a rotating bed reactor, a fluidized bed reactor, and a slurry reactor.

9: The method of claim 1, wherein the reactor is a fixed-bed reactor in the form of a cylindrical reactor comprising:
a top portion;
a cylindrical body portion;
a bottom portion;
a housing having an open top and open bottom supportably maintained with the cylindrical body portion;
wherein the Ni-SMR catalyst is supportably retained within the housing permitting fluid flow therethrough;
at least one propeller agitator disposed in the bottom portion of the reactor;
wherein the bottom portion is cone shaped or pyramidal; and
wherein a plurality of recirculation tubes fluidly connects the bottom portion of the cylindrical reactor with the cylindrical body portion of the cylindrical reactor.

10: The method of claim 9, wherein the reactor has an aspect ratio of length (L) to inner diameter (ID) of 10:1 to 50:1.

11: The method of claim 1, wherein the passing the H₂-containing feed gas stream through the reactor is carried out at a weight hourly space velocity of about 9000 mL/g_{cat}/hr at a temperature of about 700° C.

12: The method of claim 1, wherein the passing the NH₃-containing feed gas stream through the reactor is carried out at a weight hourly space velocity of 4500 to 8100 mL/g_{cat}/hr at a temperature of about 500 to 600° C.

13: The method of claim 12, having an ammonia conversion of 60 to 99% based on an initial concentration of the NH₃ in the feed gas stream.

14: The method of claim 1, further comprising:
preparing the Ni-SMR catalyst by:
calcining an industrial waste material at a temperature of about 800° C. to form a treated material;
dispersing the treated material in water and sonicating to form a dispersion;
mixing the dispersion, a Ni salt, and an alkaline solution to form a slurry and heating the slurry to form a crude product suspended in the slurry;
removing the crude product from the slurry, washing and calcining at a temperature of about 550° C. to form the Ni-SMR catalyst;
wherein the Ni-SMR catalyst has a Ni content of about 10 to 20 wt. % based on the total weight of the Ni-SMR catalyst.

15: The method of claim 14, wherein the industrial waste material comprises about 40 to 60 wt. % Fe₂O₃, about 10 to 30 wt. % Al₂O₃, about 10 to 30 wt. % SiO₂, less than 10 wt. % CaO, and less than 10 wt. % Na₂O, each wt. % based on a total weight of the industrial waste material.

16: The method of claim 15, wherein the industrial waste material comprises about 50 wt. % Fe₂O₃, about 20 wt. % Al₂O₃, about 20 wt. % SiO₂, less than 10 wt. % CaO, and less than 10 wt. % Na₂O, each wt. % based on the total weight of the industrial waste material.

17: The method of claim 14, wherein the treated material has a specific surface area in a range of 15 to 25 square meter per gram (m²/g).

18: The method of claim 14, wherein the treated material has a cumulative pore volume in a range of 0.05 to 0.06 cubic centimeter per gram (cm³/g).

19: The method of claim 14, wherein the Ni salt comprises nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate.

20: The method of claim 14, wherein the alkali solution comprises at least one alkali salt selected from the group consisting of potassium hydroxide (KOH), sodium hydroxide (NaOH), calcium hydroxide (Ca(OH)₂), potassium carbonate (K₂CO₃), sodium carbonate (Na₂CO₃), and calcium carbonate (Ca₂CO₃).
